(19) United States
(12) Patent Application Publication
(10) Pub. No.: US 2013/0110931 A1
(43) Pub. Date: May 2, 2013

(54) Scalable Peer To Peer Streaming For Real-Time Data

(71) Applicant: The Board of Trustees of the University of Illinoi, Urbana, IL (US)

(72) Inventors: Joohwan Kim, Urbana, IL (US); Rayadurgam Srikant, Urbana, IL (US)

(73) Assignee: The Board of Trustees of the University of Illinois, Urbana, IL (US)

(21) Appl. No.: 13/667,358

(22) Filed: Nov. 2, 2012

Related U.S. Application Data
(60) Provisional application No. 61/554,523, filed on Nov. 2, 2011.

(51) Int. Cl. G06F 15/16

(52) U.S. Cl. 709/204

(57) ABSTRACT

A peer to peer network includes multiple communication layers, each specifying a path through which network peers send data through the peer to peer network. A network peer in the peer to peer network may receive data from a parent network peer and send data to a child network peer. The network peer may identify communication interruption caused by the child network peer and a subsequent downstream network peer leaving the peer to peer network. The network peer may resolve the communication interruption by identifying a new child peer, for example, by accessing a descendant list of multiple levels. The peer to peer network may increase the streaming rate or streaming quality using the peers that have higher or better communication capacities. The peer to peer network may accommodate multiple channels for video/audio or other types of real-time data broadcasted by different or same network peers.

### CROSS REFERENCE TO RELATED APPLICATIONS

This application claims the benefit of and incorporates by reference U.S. Provisional Patent Application Ser. No. 61/554,523, filed on Nov. 2, 2011, and titled “P2P Streaming Over Dynamic Random M-Regular Graphs.”

### FEDERALLY SPONSORED RESEARCH OR DEVELOPMENT

This invention was made with government support under contract number CNS0964081 awarded by the National Science Foundation. The U.S. Government has certain rights in this invention.

### TECHNICAL FIELD

This disclosure relates to peer to peer streaming. This disclosure also relates to scalable peep to peer streaming of real-time data.

### BACKGROUND

Rapid advances in electronics and communication technologies, driven by immense user demand, have resulted in vast interconnected networks of computing devices capable of exchanging immense amounts of data. Communication networks may connect dozens or hundreds of computing devices. Perhaps the best known example of such interconnection of computing devices is the Internet or the World Wide Web, which continues to expand with each passing day. As technology continues to advance and interconnected computer networks grow in size and frequency of use, there is an increasing incentive to send and receive data more efficiently.

### BRIEF SUMMARY OF THE INVENTION

In one aspect, a network peer receives data from one or more parent network peers in a peer to peer network. The network peer sends data to one or more child network peers in the peer to peer network. The network peer may identify a communication interruption as a result of multiple network peers leaving the peer to peer network, such as a child network peer and a subsequent downstream network peer with respect to the network peer. The network peer may resolve the communication interruption by identifying a new child network peer and sending data to the new child network peer.

In another aspect, a device includes peer logic for communication across a peer to peer network. The device may receive a first data stream from a first parent network peer in the peer to peer network and a second data stream from a second parent network peer in the peer to peer network. The device may further receive data from a third network peer in the peer to peer device, where the received data includes the first data stream or the second data stream.

### BRIEF DESCRIPTION OF THE DRAWINGS

The innovation may be better understood with reference to the following drawings and description. In the figures, like reference numerals designate corresponding parts throughout the different views.

FIG. 1 shows an example of a peer to peer network.

FIG. 2 shows an example of a communication layer in a peer to peer network.

FIG. 3 shows an example of a new network peer joining a communication path of a communication layer in the peer to peer network.

FIG. 4 shows an example of a network peer leaving a communication path of a communication layer in the peer to peer network.

FIG. 5 shows an example of multiple network peers leaving a communication path of a communication layer in the peer to peer network.

FIG. 6 shows an example of a peer to peer network with multiple communication layers.

FIG. 7 shows an example of a network peer joining a peer to peer network with multiple communication layers.

FIG. 8 shows an example of a network peer.

FIG. 9 shows an example of logic that the network peer may implement in hardware, software, or both.

FIG. 10 shows an example of real-time data distribution in a peer to peer network.

FIG. 11 shows an example of real-time data distribution in a peer to peer network.

FIG. 12 shows an example of real-time data distribution in a peer to peer network.

FIG. 13 shows an example of logic that a network peer may implement as hardware, software, or both.

FIG. 14 shows an example of a peer to peer network that includes heterogeneous network peers.

FIG. 15 shows an example of a peer to peer network that includes heterogeneous network peers.

FIG. 16 shows an example of data flow in a heterogeneous peer to peer network.

FIG. 17 shows a timing example of multi-channel peer to peer streaming.

### DETAILED DESCRIPTION

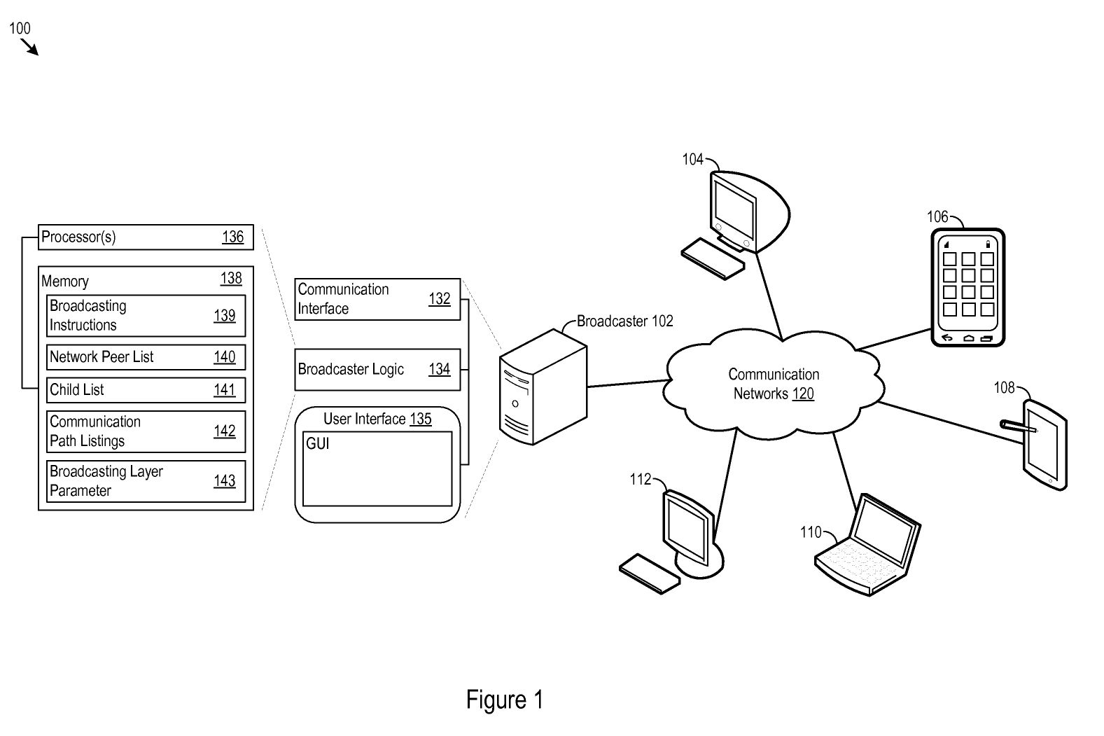

FIG. 1 shows an example of a peer to peer network 100. The peer to peer network 100 includes the broadcaster 102. The peer to peer network 100 also includes multiple network peers, such as the network peers labeled as 102-112. A network peer may be any type of electronic device that communicates network data. A network peer may take any number of forms, including as examples a laptop, desktop, or other type of computer, a personal data assistant, tablet device, portable audio player, high definition (e.g., Blu-Ray™ or DVD audio) media player, home media server, portable email device, digital television, or other electronic devices.

The broadcaster 102 may be any electronic device that distributes content. In that regard, the broadcaster 102 may be implemented one or more electronic devices, including any of the devices listed above with respect to network peers. The broadcaster 102 may be operated by a commercial entity, such as a cable provider, online content provider, or any other entity that may distribute content through broadcaster 102 as part of a commercial operation. The broadcaster 102 may be operated by a non-commercial entity, e.g., a personal user distributing content through a personal computer, laptop, music device, etc.

The broadcaster 102 and network peers 102-112 communicate with one another through the communication networks 120. The communication networks 120 may interconnect the broadcaster 102 and any number of network peers according to any communication protocol, standard, or topology. The communication networks 120 may include multiple sub-networks and any number of intermediate network nodes or routing devices that interconnect the network peers and the broadcaster 102. As one example, the communication networks 120 may include the Internet.

The broadcaster 102 includes a communication interface 132, broadcaster logic 134, and user interface 135. The communication interface 132 communicates data to and from the broadcaster 102. For instance, the communication interface 132 sends real-time data from the broadcaster 102 to selected network peers in the peer to peer network 100. The broadcaster logic 134 implements as hardware, software, or both, any of the functionality associated with the broadcaster 102. As one example, the broadcaster logic 134 includes a processor 136 and a memory 138. The memory 138 stores, for example, broadcaster instructions 139, a network peer list 140, a child list 141, communication path listings 142, and a broadcasting layer parameter 143. The network peer list 140 may identify the network peers currently part of the peer to peer network 100, e.g., networks currently sending or receiving data in the peer to peer network 100. The child list 141 may specify a set of network peers that the broadcaster 102, in particular, transmits data to. The broadcasting layer parameter 143, as discussed in greater detail below, may specify the number of communication layers maintained by the peer to peer network 100. A communication layer may refer to a particular communication path in the peer to peer network 100 through data is propagated. The broadcaster 102 may accept input from the user interface 135 to change, view, add, or delete the broadcasting layer parameter 143 or any other parameters associated with the peer to peer network 100.

In one variation, some or all of management of the peer to peer network 100 may be handled by other management logic instead of the broadcaster 102, such as through a separate management server. The management server may implement any functionality discussed below with regards to managing the peer to peer network 100. To that end, the management server may maintain and utilize the network peer list 140, communication path listings 142, broadcasting layer parameter 143, or other network parameters to manage the peer to peer network 100.

In operation, the broadcaster 102 seeds data to the peer to peer network 100 by sending the data to the network peers specified in the child list 141 of the broadcaster 102. As one example, the broadcaster 102 may be a content provider that seeds real-time data, such as an Audio/Video (A/V) program, to the peer to peer network 100. The child list 141 of the broadcaster 102 may include a subset of the network peer list 140. In other words, the broadcaster 102 sends data, e.g., the A/V program, to a particular subset of the network peers in the peer to peer network 100, as specified by the child list 141. The network peers that receive the data from the broadcaster 102 may, in turn, send the received data to additional network peers in the peer to peer network 100. A “child” or “children” of a first network peer may refer to the one or more network peers that the first network peer sends data to. A “parent” or “parents” of the first network peer may refer to the one or more network peers that the first network peer receives data from. Preceding upstream network peers of a particular network peer may be expressed in terms of ancestry (e.g., parent, grandparent, great grandparent, etc.). In a similar way, subsequent downstream network peers of a particular network peer may be expressed as descendants (e.g., child, grandchild, great grandchild). As network peers in the peer to peer network 100 receive data from their parents and send data to their children, the data is disseminated across the peer to peer network 100. In this way, the data provided by the broadcaster 102 may eventually be received by each of the network peers in the peer to peer network 100, even though the broadcaster 102 initially sends the data to a smaller subset of the network peers in the peer to peer network 100.

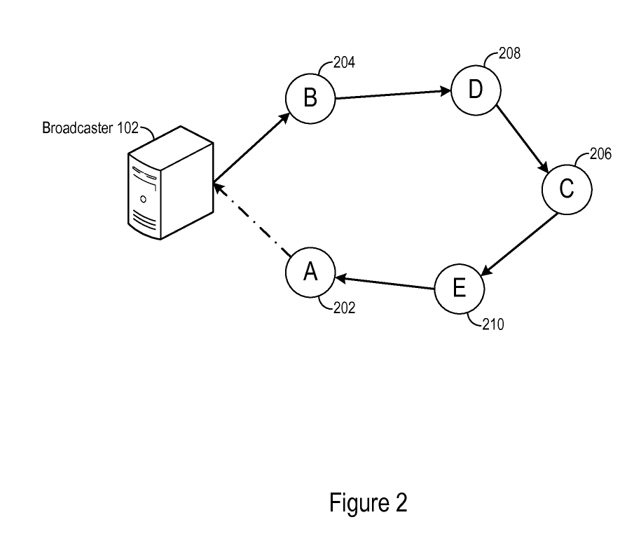

FIG. 2 shows an example of a communication layer 200 in a peer to peer network 100. The communication layer 200 may include a communication path, e.g., order, through which data from the broadcaster 102 is transmitted to the network peers of the peer to peer network 100. In the example shown in FIG. 2, the peer to peer network 100 includes the broadcaster 102 and the five network peers labeled as network peer A 202, network peer B 204, network peer C 206, network peer D 208, and network peer E 210.

The communication path of a communication layer 200 may interlink each of the network peers of the peer to peer network 200. That is, each of the network peers in the peer to peer network 100 may be part of the communication path through which data from the broadcaster 102 is transmitted or propagated. In the example shown in FIG. 2, the peer to peer network 100 propagates data in the following order: Broadcaster 102 sends the data to network peer B 204; network peer B 204 sends the data to network peer D 208; network peer D sends the data to network peer C 206; network peer C 206 sends the data to network peer E 210; network peer E 210 sends the data to network peer A 202. In this way, each of the network peers A-E receives the data sent by the broadcaster 102.

Each network peer may have one parent network peer and one child network peer with respect to a communication layer 200. In FIG. 2, network peer E 210 receives data from its parent, network peer C 206, and sends data to its child, network peer A 202. Along similar lines, network peer B 204 receives data from its parent, broadcaster 102, and sends data to its child, network peer D 208. A network peer may maintain a list identifying one or more previous or subsequent network peers in the communication path of a communication layer 200, such as an ancestor list, a descendant list, or both. In one implementation, the last network peer in a communication path of a communication layer 200 may identify the broadcaster 200 as its child, even though the last network peer may forego sending the data to the broadcaster 102. Similarly, the broadcaster 102 may identify the final network last network peer of a communication path as its parent, even though the broadcaster 102 may not receive data from the last network peer. In FIG. 2, this relationship between the last network peer of a communication path and the broadcaster 102 is depicted through the dotted line linking network peer A, the last network peer of the communication path in communication layer 200, and the broadcaster 102.

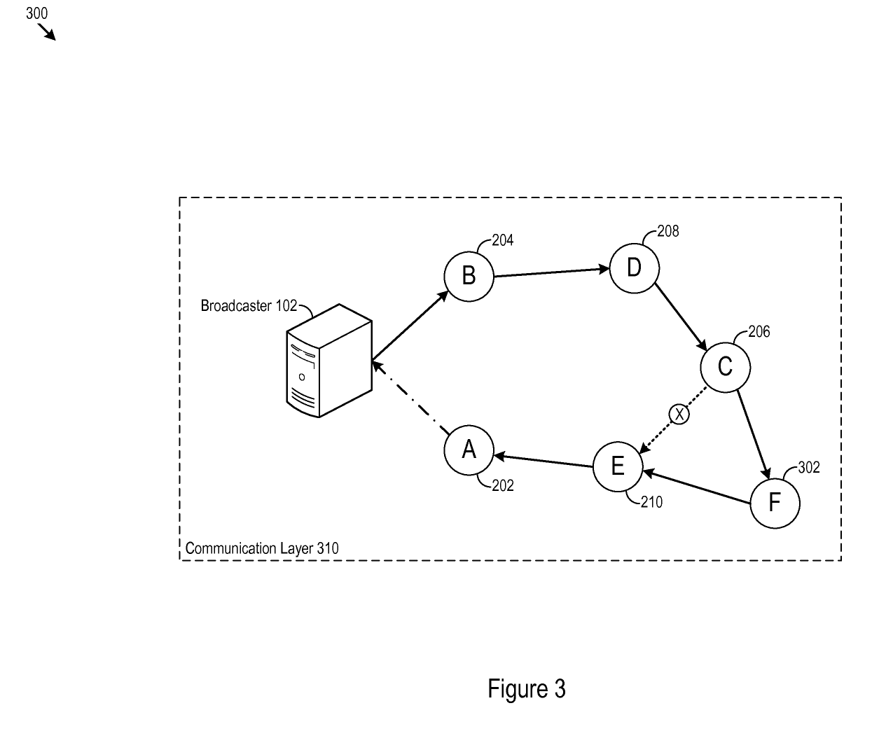

FIG. 3 shows an example 300 of a new network peer joining a communication path of a communication layer 310 in the peer to peer network 100. In FIG. 3, a new network peer labeled as network peer F 302 joins the peer to peer network 100. Network peer F 302 may query broadcaster 102 and/or a management server associated with the peer to peer network 100 to determine an insertion point in the peer to peer network 100. In that regard, network peer F 302 may receive, from the management server, an indication of a parent network peer to receive data from and/or a child network peer to send data to. In one example, network peer F 302 contacts the broadcaster 102 to obtain an identification of a parent network peer, child network peer, or both.

The broadcaster 102 may identify a parent network peer and/or child network peer for a new network peer in various ways. As one example, the broadcaster 102 may randomly select a network peer from the network peer list 140 as a parent network peer for the new network peer joining the peer to peer network 100. In one implementation, the network peer list 140 includes the broadcaster 102. In this regard, it is possible the broadcaster 102 may randomly select itself as the parent network peer for a new network peer for a particular communication path of a communication layer in the peer to peer network 100. The broadcaster 102 may then send an identification of the selected network peer to the new network peer, whereupon the new network peer may contact the selected network peer. The new network peer may send an insertion indication to the selected network peer, indicating the new network peer will insert itself into the current communication link between the selected network peer and its current child. The selected network peer may respond by indicating the child network peer that the selected network is sending data to as part of the communication path of the communication layer 310.

The new network peer may insert itself into the outgoing communication link of the selected network peer. That is, upon receiving the insertion indication, the selected network peer may send data to the new network peer, and the new network peer may send data to the previous child of the selected network peer that the new network peer replaced. In this way, the new network peer becomes the child of the selected network peer, and the previous child of the selected network peer becomes the child of the new network peer.

To provide an illustration, network peer F 302 joins the peer to peer network 100. To determine an insertion point in the communication path of the communication layer 310, network peer F 302 contacts the broadcaster 102 or other management logic associated with the peer to peer network 100. The broadcaster 102 randomly selects an existing network peer as act as the parent network peer of network peer F 302. In this example, the broadcaster 102 selects network peer C 206 as the parent network peer for network peer F 302. The broadcaster 102 sends a communication to network peer F 302 identifying network peer C 206 as the selected network peer. Network peer F 302 sends an insertion indication to network peer C 206, and, in response, network peer C 206 may send a communication to network peer F 302 identifying network peer E 210 as the current child of network peer C 206. At this point, network peer C 206 may also cease sending data to network peer E 210, and instead send data to network peer F 302. In one implementation, network peer E 210 may also receive an insertion indication from, for example, network peer C 206, network peer F 302, or the broadcaster 102. The insertion indication may indicate to network peer E 210 that network peer F 302 will now serve as the parent for network peer E 210 instead of network peer C 206.

Thus, as described above, network peer F 302 may insert itself into the outgoing communication link from network peer C 206 to network peer E 210. As a result of network peer F 302 joining the communication path of the communication layer 310, two new communication links are created. That is, after network peer F 302 joins the communication path, network peer C 206 now sends data to network peer F 302 and network peer E 210 now receives data from network peer F 302. The affected network peers, e.g., network peers C 206, F 302, and E 210, may update their child list or parent list accordingly to reflect changes in the communication path of communication 310 resulting from network peer F 302 joining the peer to peer network 100 and the communication path.

In another variation, the broadcaster 102 may select a child network peer, with respect to a particular communication layer 310, for a new network peer joining the peer to peer network 100. In this variation, the new network peer may send an insertion indication to the selected child network peer. In response, the selected child network peer may send to the new network peer, for example, an identification of the current parent network peer of the selected child network peer. In response, the new network peer may send an insertion indication to the identified parent network peer. An another option, the child network peer may send an insertion indication to its parent network peer, which may instruct the parent network peer to now send data to the new network peer instead of the selected child network peer. Accordingly, the new network peer may join the communication path of the communication layer 310, and each of the affected network peers may respectively update their descendant list and/or ancestor list. When a new network peer joins the peer to peer network 100, the broadcaster 102 may update the network peer list 140 to identify the new network peer.

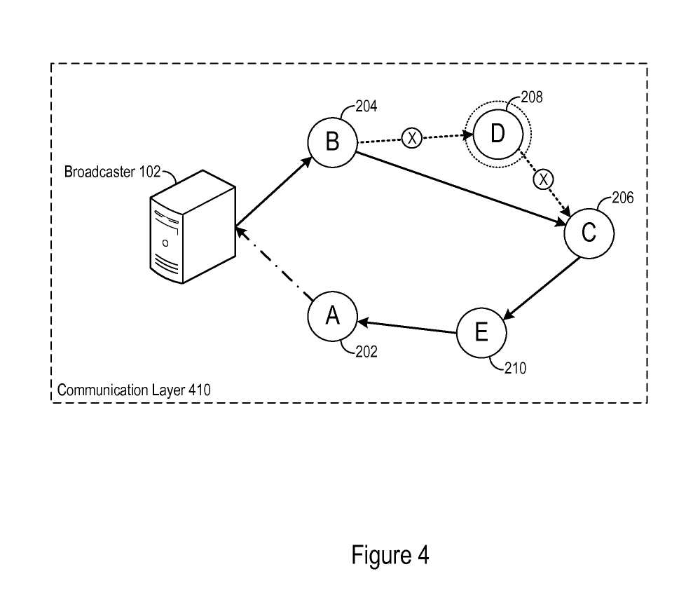

FIG. 4 shows an example 400 of a network peer leaving a communication path of a communication layer 410. In the example shown in FIG. 4, network peer D 208 leaves the peer to peer network 100. This may occur when network peer D 208 voluntarily leaves the peer to peer network 100, such as when a user of network peer D 208 exits a software application connecting network peer D 208 to the peer to peer network 100, when network peer D 208 shuts down (e.g., powers off), etc. Network peer D 208 may involuntarily leave the peer to peer network 100 as well, such as when a network connection that network peer D 208 utilizes becomes unavailable, when network peer D 208 is forcibly disconnected from a communication network, or according to other scenarios.

A network peer may obtain an unavailability indication when its child network peer has left the peer to peer network 100, a communication path, a communication layer 410, or any combination thereof. In FIG. 4, network peer B 204 obtains an unavailability indication when its child network peer, network peer D 208, leaves the peer to peer network 100. Network peer B 204 may identify unavailability of network peer D 208 when the network peer B 204 fails to receive any communication from network peer D 208 for a predetermined amount of time, e.g., as specified by an unavailability timing parameter. Network peer B 204 may determine that network peer D 208 is unavailable when network peer B 204 fails to identify any activity from network peer D 208 for a length of time that exceeds the unavailability timing parameter. As examples, network peer B 204 may fail to receive, within the specified timing, a periodic activity communication from network peer D 208 or a confirmation, e.g., confirmation packet after transmitting data to network peer D 208, as examples. In another example, network peer B 204 may receive an unavailability communication from the broadcaster 102 indicating that network peer D 208 has left the peer to peer network 100. As a further example, network peer B 204 may receive an unavailability communication from network peer C 206, e.g., the child of network peer D 208 and the grandchild of network peer B 204, indicating that network peer D 208 has failed to send data to network peer C 206 beyond a particular unavailability timing threshold of the grandchild network peer.

In response to obtaining an unavailability indication regarding a child network peer, the network peer may resolve a communication interruption in the peer to peer network 100 and/or communication layer 410. In FIG. 4, network peer C 206 may no longer receive data from its parent network peer when network peer D 208 leaves the peer to peer network 100, thereby resulting in a communication interruption in the peer to peer network 100. Consequently, downstream network peers subsequent to network peer C 206, such as network peer E 210 and network peer A 202, may likewise cease receiving data as a result of the communication interruption. Network peer B 204 may determine that network peer D 208 has left the peer to peer network 100, for example by obtaining an unavailability indication in any of the ways discussed above. In response, network peer B 204 may resolve the communication interruption by contacting the child of the departed network peer, e.g., network peer C 206. Network peer B 204 may then send data to network peer C 206 instead of to network peer D 208, thus repairing the communication interruption and ensuring data continues to propagate through the communication path of the communication layer 410 in the peer to peer network 100.

In order to resolve a communication interruption caused by a departed child network peer, a network peer may maintain a listing of multiple levels of descendants in a communication path of a communication layer 410, e.g., the network peer's child, grandchild, great grandchild, etc. The network peer may obtain a descendant listing with multiple levels from the network peer's child for a particular communication layer 310, e.g., by requesting the child network peer's descendant listing upon insertion into the communication path of a communication layer 410 and modifying the received descendant list to add the child network peer as the direct descendant of the network peer and/or remove the furthest descendant of the child network peer from the descendant listing of the network peer. A network peer may also maintain an ancestor listing of multiple levels, e.g., received from a selected parent network peer upon joining a communication layer 410 of the peer to peer network 100.

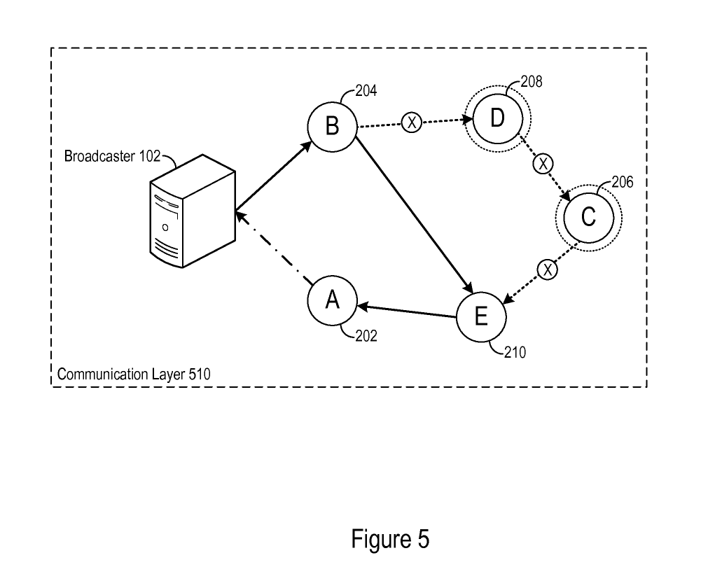

FIG. 5 shows an example 500 of multiple network peers leaving a communication path of a communication layer. Network peers may join or leave a peer to peer network 100 in significant numbers. For example, a peer to peer network 100 propagating an A/V broadcast may experience particular times when multiple network peers join or leave, e.g., during a commercial in the A/V broadcast, when a particular A/V program ends or begins, etc. Thus, as mentioned above, a network peer may maintain a descendant listing and an ancestor listing that may span multiple levels, e.g., hops within a communication path of a communication layer 510.

By maintaining a descendant listing of three or more levels, a network peer may repair a communication interruption when two or more consecutive descendants leave the peer to peer network 100, e.g., simultaneously or within a predetermined timing threshold. In the example shown in FIG. 5, network peer B 204 maintains a descendant listing of at least 3 levels. Specifically, the descendant listing of network peer B 204 identifies: (i) network peer D 208 as the child of network peer B 204; (ii) network peer C 206 as the grandchild of network peer B 204; and network peer E 210 as the great grandchild of network peer B 204. Thus, network peer B 204 may repair a communication interruption when both network peers D 208 and C 206 leave the peer to peer network 100 and the communication layer 510.

Network peer B 204 may obtain unavailability indication for both network peer D 208 and network peer C 206 in similar ways as discussed above. For example, network peer B 204 may identify a lack of communication activity with network peer D 208 that exceeds a predetermined unavailability timing parameter. In response, network peer B 204 may contact the subsequent descendant in the communication path, which in FIG. 5 is network peer C 206. Network peer B 204 may attempt to contact network peer C 206 to repair the communication interruption caused by the unavailability of network peer D 208. In doing so, network peer B 204 may obtain an unavailability indication with regards to network peer C 206 as well, e.g., when network peer C 206 fails to respond to communications from network peer B 204. Network peer B 204 may continue to the next descendant in the descendant list of network peer B 204, which network peer B 204 identifies as network peer E 210. Then, network peer B 204 may repair the communication interruption by coordinating with network peer E 210. Accordingly, network peer B 204 may send data to network peer B 210, thus repairing the communication interruption caused by the departure of network peer D 208 and network peer C 206.

As another example, network peer E 210 may obtain an unavailability indication with respect to its parent network peer, network peer C 206. This may occur when network peer E 210 fails to receive data from network peer C 206 for a length of time that exceeds a predetermined threshold, e.g., the unavailability timing parameter. In response, network peer E 210 may attempt to contact the direct ancestor, e.g., parent, of network peer C 206, which network peer E 210 identifies as network peer D 208 according to its ancestor list. Network peer E 210 may fail to receive a response from network peer D 208, and accordingly contact the next ancestor on the ancestor list, which network peer E 210 identifies as network peer B 204. Thus, network peer E 210 and network peer B 204 may coordinate to repair the communication interruption.

Upon repairing the communication interruption, one or more network peers in the peer to peer network 100 may update their respective descendant list and/or descendant list for a particular communication layer 510. As seen in FIG. 5, upon repairing the communication interruption caused by departed network peers D 208 and C 206, a new communication link is formed between network peer B 204 and network peer E 210.

The parent network peer of a newly created communication link may update its descendant list to reflect the changes to the communication path of the communication layer 510. In FIG. 5, network peer B 204 may, for example, request the descendant list of network peer E 210 in order for network B 204 to update its descendant list. Prior to the communication interruption repair, network peer B 204 may maintain a descendant list of three levels with a content of: {network peer D 208 (child); network peer C 206 (grandchild); network peer E 210 (great grandchild)}. After the communication interruption repair, network peer B 204 may receive the descendant list of network peer E to determine the subsequent descendants of network peer E. Thus, after the communication interruption repair, network peer B 204 may update its descendant list to have a content of {network peer E 210 (child); network peer A 202 (grandchild); broadcaster 102 (great grandchild)}. Network peer B 204 may then transmit the updated descendent list to its parent (e.g., Broadcaster 102) so that the parent can update its descendent list accordingly. Moreover, an updated descendent list may be propagated by one or more network peers to any ancestor whose respective descendent list includes network peer D 208, network peer C 206, or both. Each preceding ancestor whose descendant list is affected by the newly created communication link can update their particular descendant list accordingly. This propagated descendant list update process may occur for each communication layer that the new network peer joins.

The child network peer of a newly created communication link may update its ancestor list to reflect the changes to the communication path of the communication layer 510. For example, network peer E 210 may request the ancestor list of network peer B 204. Thus, network peer E 210 may modify the contents of its ancestor list from {network peer C 206 (parent); network peer D 208 (grandparent); network peer B 204 (great grandparent)}, reflective of prior to the communication interruption, to {network peer B 204 (parent); Broadcaster 102 (grandparent)}, reflective of after repair of the communication interruption caused by the departure of network peers C 206 and D 208. Network peer E 210 may then transmit an updated ancestor list to its child (e.g., network peer A 202) so that the child can update its ancestor list accordingly. An updated ancestor list may be propagated by one or more network peers to any descendant whose respective ancestor list includes network peer D 208, network peer C 206, or both. Each subsequent descendant whose descendant list is affected by the newly created communication link can update their particular ancestor list accordingly. This propagated ancestor list update process may occur for each communication layer that the new network peer joins.

In one variation, the broadcaster 102 may maintain a communication path listing 142, which may indicate a complete ancestor and/or descendant list for a communication layer 510. That is, the communication path listing 142 may specify the communication path, e.g., complete order of network peers, which data is transmitted across a communication layer 510. The child and/or parent network peer in a newly created communication link may communicate a link indication to the broadcaster 102, e.g., upon repairing a communication interruption, upon insertion of a new network peer into the communication path of a communication layer, etc. The link indication may specify any information regarding the newly created communication link, including the new parent network peer, the new child network peer, any departed network peers, any severed connections, or other information. Upon receiving the link indication, the broadcaster 102 may update the communication path listing 142 of a communication layer, the network peer list 140, or both. In one implementation, the communication path listing may be implemented as an ordered version of the network peer list 140.

Thus, as discussed above, a network peer may maintain an ancestor list and/or descendant list of multiple levels, for example for “M” number of levels. In one scenario, M successive peers of a network peer leave the peer to peer network 100 before the network peer can repair the resulting communication interruption. For example, network peers in the peer to peer network 100 maintain ancestor and descendant lists of 3 levels. In this example, if a first network peer identifies that its 3 successive descendants have left the network, the first network peer may be unable to contact the next successive descendant, e.g., a second network peer. Instead, the first network peer may contact the broadcaster 102 to repair the communication interruption, providing an indication of the unavailability of its three successive descendants. In a similar scenario, the second network peer, who is the fourth descendant of the first network peer, identifies that its 3 successive ancestors have left the network. In response, the second network peer may contact the broadcaster 102 to repair the communication interruption, providing an indication that its three successive ancestors are unavailable. The broadcaster 102 may link first network peer and the second network peer, for example, by identifying a commonality in number and/or identity of departed network peers indicated by the first and second network peers. As another variation, the broadcaster 102 may access the communication path listing 142 of a particular communication path to determine that the first and second network peers are four hops apart. Thus, to repair the communication interruption caused by the departure of the three intermediate hops between the first and second network peers, the broadcaster 102 may send and identification of the second network peer as a child for the first network peer and/or identification of the first network peer as a parent for the second network peer.

Thus, by maintaining ancestor and descendant lists with multiple levels, e.g., three or more, the network peers of a peer to peer network 100 may repair one or more communication interruptions resulting from multiple departing network peers. Similarly, the broadcaster 102 may assist in repairing communication interruptions when the number of successive peers departing exceeds the number of descendants and/or ancestors identified in lists maintained by network peers. In doing so, the robustness of the peer to peer network 100 may be increased, allowing the network to recover and continue distributing data even when multiple network peers leave simultaneously or in a narrow time frame.

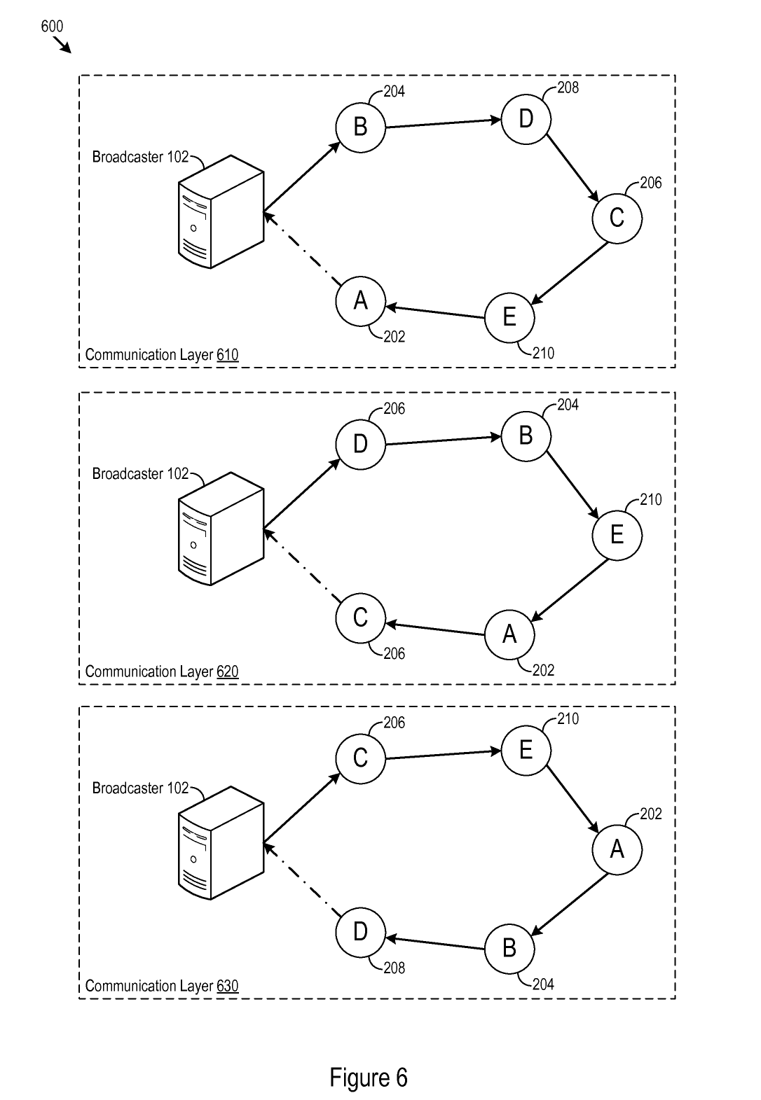

FIG. 6 shows an example 600 of a peer to peer network 100 with multiple communication layers. The peer to peer network 100 includes, in this example, the five network peers labeled as network peer A 202, network peer B 204, network peer C 206, network peer D 208, and network peer E 210. The peer to peer network 100 may simultaneously maintain any number of communication layers though which the network peers propagate data. In that regard, each network peer may receive data and send data across different communication paths according to each communication layer. In FIG. 6, the peer to peer network 100 maintains three communication layers, labeled as communication layer 610, 620, and 630. Each of the communication layers 610, 620, and 630 includes each of the network peers A 202, B 204, C206, D 208, and E 210. Each of the network peers 202-210 may divide their upload and download capabilities among the three communication layers 610, 620, and 630, e.g., evenly for each communication layer. The number of communication layers maintained by the peer to peer network 100 may be specified as the broadcasting layer parameter 143 stored by the broadcaster 102.

Each of the communication layers 610, 620, and 630 respectively specify a communication path through which data in the respective communication layer is communicated. Thus, the broadcaster 102 may maintain a communication path listing 142 for each of the communication layers in the peer to peer network 100. In FIG. 6, the communication path listing 142 for communication layer 610 specifies an order of {network peer B 204, network peer D 208, network peer C 206, network peer E 210, network peer A 202}. The communication path listings 142 for communication layers 620 and 630 respectively specify an order of {network peer D 208, network peer B 204, network peer E 210, network peer A 202, network peer C 206} and {network peer C 206, network peer E 210, network peer A 202, network peer B 204, network peer D208}.

The communication path order for each communication layer may differ based on where the broadcaster 102 inserts a new network peer joining the peer to peer network 100 for each communication layer. For example, the broadcaster 102 may randomly select a parent node for each communication layer when a new network peer joins the peer to peer network 100. Thus, the new network peer may be inserted into different locations of a communication path for each communication layer, which may result in a differing order for each communication layer.

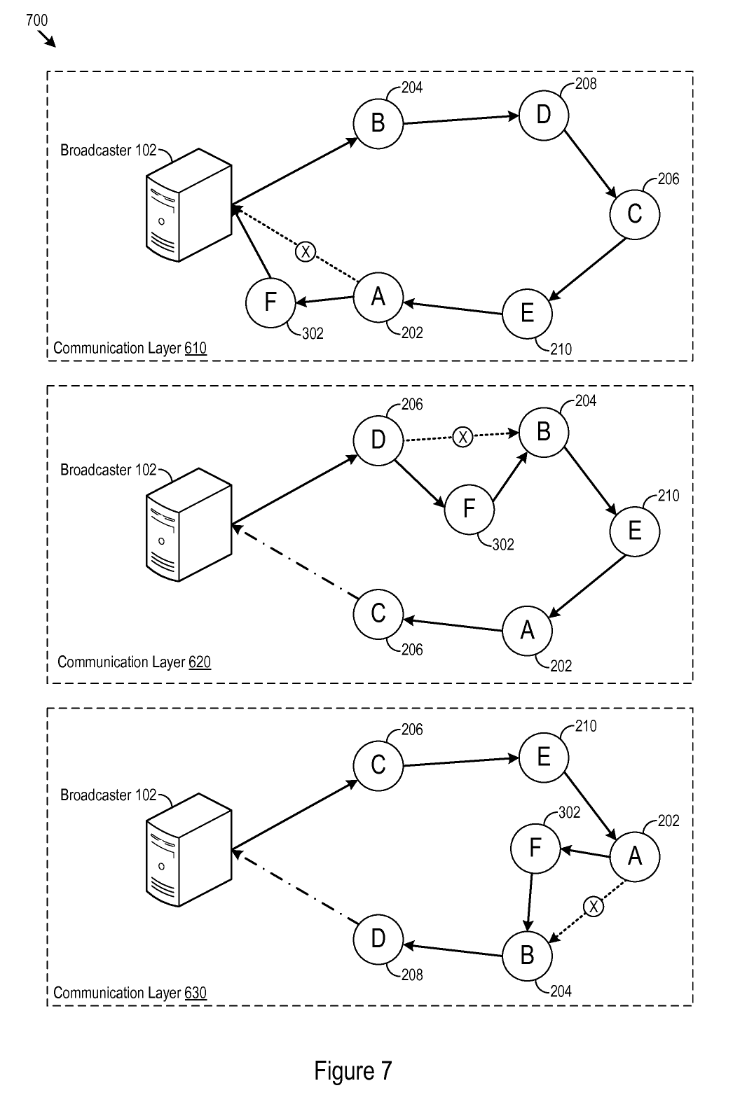

FIG. 7 shows an example 700 of a network peer joining a peer to peer network with multiple communication layers. In FIG. 7, network peer F 302 joins the peer to peer network 100, which includes three communication layers 610, 620, and 630. Network peer F 302 communicates with broadcaster 102, for example to request an insertion position in the peer to peer network 110. The broadcaster 102 may respond by indicating the number of communication layers in the peer to peer network 100, insertion positions in the communication layers, or both. The broadcaster 102 may select a parent network peer for each of the communication layers 610, 620, and 630 for network peer F 302, e.g., by randomly selecting three or more network peer is the peer to peer network 100.

In the example shown in FIG. 7, the broadcaster 102 randomly selects for network peer F 302: (i) network peer A 202 as the parent network peer for communication layer 610; (ii) network peer D 206 as the parent network peer for communication layer 620; and (iii) network peer A 202 as the parent network peer for communication layer 630. Network peer F 302 may insert itself into each respective communication path for communication layers 610, 620, 630 similarly as described above, e.g., with respect to FIG. 3.

As seen in FIG. 7, network peer F 302 may join a different position in each communication path of the three communication layers 610, 620, and 630. A network peer may share one or more common parent or child network peers for different communication layers. For example, network peer F 302 identifies network peer A 202 as a parent network peer for both communication layer 610 and communication layer 630. As another example, network peer F 302 identifies network peer B 204 as a child network peer for both communication layers 620 and 630. However, as seen in FIG. 7, each of the communications paths for communication layers 610, 620, and 630 are distinct, despite sharing some common parent-child communication links along the respective communication paths.

FIG. 7 describes how a new network peer joins a peer to peer network 100 with multiple communication layers. A network peer in a peer to peer network 100 with multiple communication layers may repair one or more communication interruptions caused by one or more departing network peers as well. For example, one or more network peers for each communication layer may repair a communication interruption in any of the ways described above.

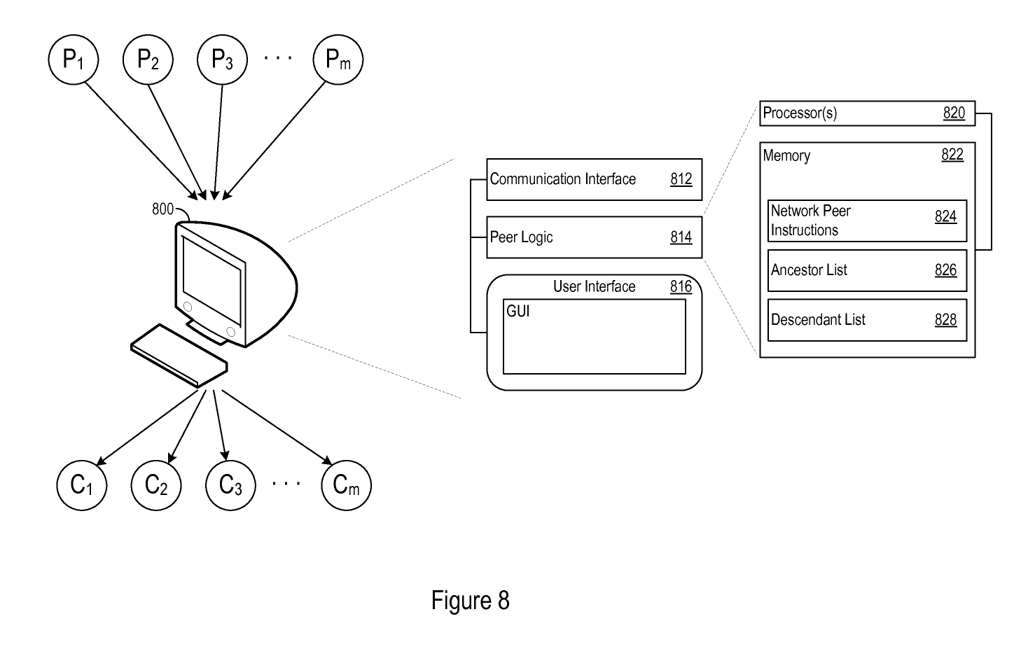

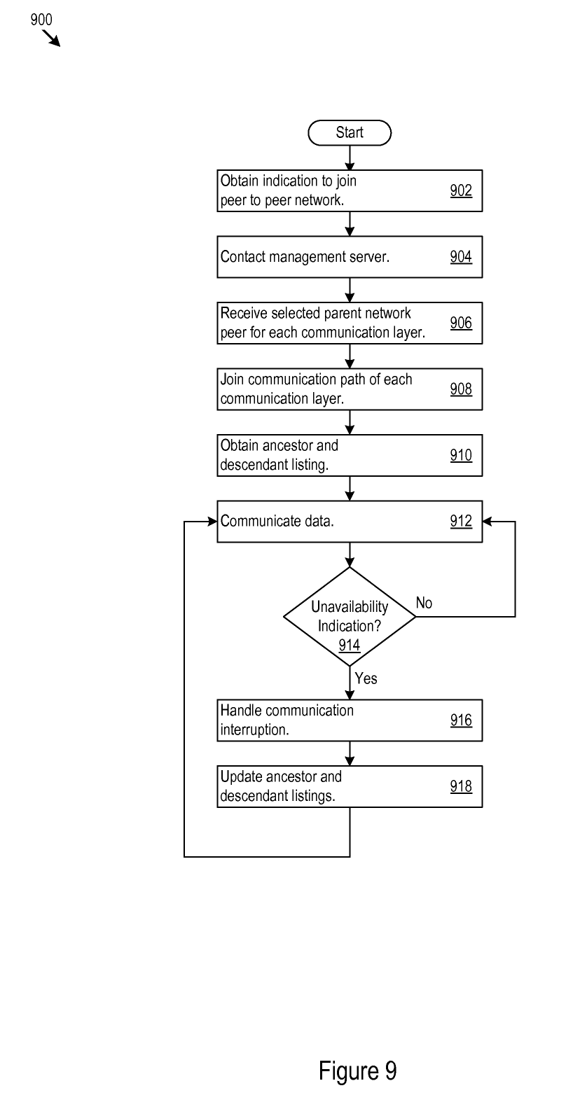

FIG. 8 shows an example of a network peer 800 of a peer to peer network 100. The network peer includes a communication interface 812, peer logic 814, and the user interface 816. The communication interface 812 may, for example, receive data from one or more parent network peers of the network peer 800, send data to one or more child network peers of the network peer 800, otherwise communicate with other network peers, the broadcaster 102, or other perform communications. The peer logic 814 implements as hardware, software, or both, any of the functionality associated with the network peer 800, e.g., as described above in FIGS. 1-7 or below in FIGS. 9-14. The peer logic 814 may include a processor 820 and a memory 822. In one implementation, the memory 822 stores network peer instructions 824, an ancestor list 826, and a descendant list 828. The network peer 800 may receive input the user interface 816, including any changes to

In operation, the network peer 800 may receive data from one or more network peers identified as parents in the ancestor list 826. The ancestor list 826 may identify a predetermined number of parents through which the network peer 800 receives data. The ancestor list 826 may identify an ancestor listing of the network peer 800, e.g., parent, grand parent, great grandparent, etc., for each communication layer implemented in the peer to peer network 100.

In the example shown in FIG. 8, the network peer 800 receives data from M number of parent network peers. Each of the M number of parent network peers may be associated with a particular communication layer in the peer to peer network 100. That is, the data that the network peer 800 receives from a particular parent network peer corresponds to a particular communication path in the peer to peer network 100 of a particular communication layer.

The network peer 800 sends data to its child network peers, as specified by the descendent list 828. The descendant list 828 may identify descendant listing of the network peer 800, e.g., child, grandchild, great grandchild, etc., for each communication layer implemented in the peer to peer network 100. In FIG. 2, the network peer 800 sends data to M number of child network peers. Each of the M child network peers may be associated with a particular communication layer and communication path in the peer to peer network 100.

The ancestor list 826 and/or descendant list 828 may identify a network peer in any number of ways. For example, the ancestor and descendant lists 826 and 828 may identify a network peer by IP address, MAC address, device name, or through any other identifying information associated with the network peer. The ancestor list 826 and descendant list 828 may additionally or alternatively identify, as examples, the level of ancestry with respect to the network peer 800, e.g., number of hops previous or subsequent to the network peer 800, the communication layer a particular ancestor or descendant corresponds to, or both.

FIG. 9 shows an example of logic the network peer 800 may implement as hardware, software, or both. The network peer 800 may obtain an indication to join a peer to peer network 100 (902). For example, a user of the network peer 800 may initiate a software application or tune to a broadcast prompting the network peer 800 to join the peer to peer network 100. The network peer 800 may contact a management server (904), which may be implemented the broadcaster 102.

The network peer 800 may receive any number of peer to peer parameters, instruction, or other data with respect to the peer to peer network 100 from the broadcaster 102. As one example, the network peer 800 may receive an indication of the number of communication layers in the peer to peer network 100 as well as an insertion point for each communication layer (906). The insertion point may include a selected parent network peer that the network peer 800 whose outgoing communication link the network peer 800 may break into. In that regard, the network peer may join the communication path of each communication layer in the peer to peer network 100 (908), e.g., by sending an insertion indication to a selected parent network peer, a child network peer of the selected parent, or both.

The network peer 800 may obtain an ancestor list 826, a descendant list 828, or both (910). The network peer 800 may obtain its ancestor list 826 by modifying an ancestor list 826 received from a parent network peer. The network peer 800 may obtain its descendant list 828 by modifying a descendant list 828 received from a child network peer.

The network peer 800 communicates data in the peer to peer network 100 (912). For each communication layer, the network peer 800 receives data from a parent network peer and sends data to a child network peer. The network peer 800 may continue to communicate data until, for example, identifying an unavailability indication (914) of one or more parent network peers, one or more child network peer, or any combination both. The network peer 800 may also identify unavailability indications with respect to successive levels of ancestry (e.g., parent, grandparent, or more) and/or successive levels of descendants (e.g., child, grandchild, or more). Then, the network peer 800 may handle, e.g., repair, a communication interruption associated with the unavailability indication in any of the ways described above (916). Upon handling the communication interruption, the network peer 800 may update its ancestor list 826 and/or descendant list 828 to reflect changes to the communication path of one or more communication layers in the peer to peer network 100.

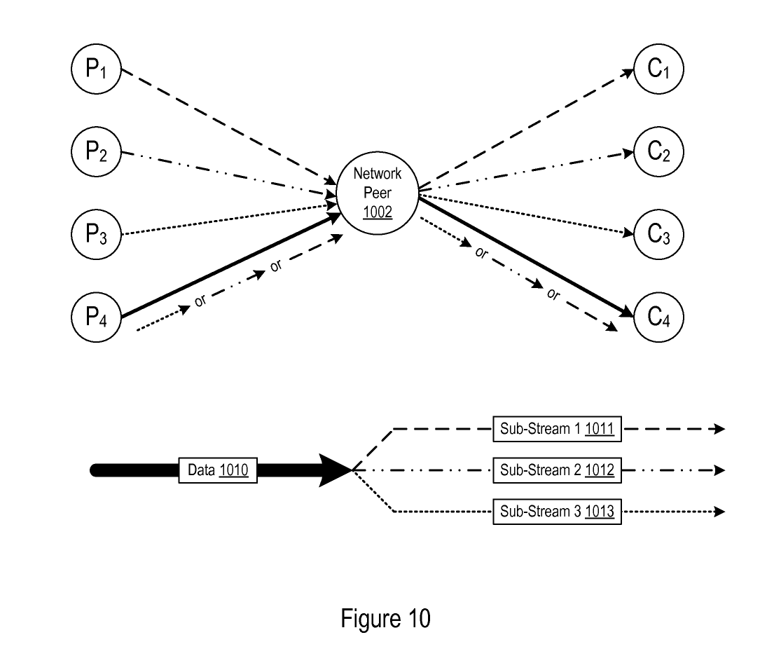

FIG. 10 shows an example of real-time data distribution 1000 in a peer to peer network 100. The example shown in FIG. 10 includes the network peer 1002, which may join the peer to peer network 100 in any of the ways discussed above. The peer to peer network 100 includes multiple communication layers and a corresponding communication path for each layer. In FIG. 10, the peer to peer network 100 includes 4 communication layers. As such, the network peer 1002 receives data from the four parent network peers labeled as P₁, P₂, P₃, and P₄. The network peer 1002 sends data to the four child network peers labeled as C₁, C₂, C₃, and C₄. Each subscript may refer to a particular communication layer the parent or child network peer is associated with. Thus, for a first communication layer, the network peer 1002 may receive data from parent network peer P₁ and send the data received from parent network peer P₁ to child network peer C₁.

The broadcaster 102 distributes real-time data 1010 across the peer to peer network 100 by sending the real-time data to the child network peer of the broadcaster 102 for each respective communication layer of the peer to peer network 100. The broadcaster 102 may split the real-time data 1010 into a predetermined number of data sub-streams. Data carried by a data sub-stream may be the same as none, some, or all, of the data carried by another data sub-stream. In one implementation, the broadcaster 102 splits the real-time data 1010 into data sub-streams that carry different portions of the real-time data 1010, e.g., each of the data sub-streams are different. A data sub-stream may carry distinct portions of the real-time data 1010, such as an audio portion, a video portion, a certain number of frames, a particular time period of an A/V program, or any other distinct portion of a data stream. As another example, the real-time data 1010 may include data multiplexed from multiple data streams, e.g., A/V programs from multiple channels. The broadcaster 102 may split the real-time data 1010 according to each channel and distribute channel data across each data sub-stream.

The broadcaster 102 may split the real-time data 1010 into a number of sub-streams that is less than the number of communication layers in the peer to peer network 100. For example, in FIG. 10, the broadcaster 102 splits the real-time data 1010 into the three data sub-streams labeled as stream 1 1011, stream 2 1012, and stream 3 1013, which are distributed across the peer to peer network 100 that includes four communication layers.

A communication layer may be associated with a particular sub-stream. In FIG. 10, for example, stream 1 1011 is associated with a first communication layer, stream 2 1012 is associated with a second communication layer, and stream 3 1013 is associated with a third communication layer. Accordingly, network peer 1002 receives data of stream 1 1011 from parent network peer P₁ and sends data of stream 1 1011 to child network peer C₁. A similar process occurs to distribute stream 2 1012 data across communication layer 2 and stream 3 1013 data across communication layer 3.

The broadcaster 102 may configure the association of a particular data sub-stream with a communication layer. The broadcaster 102, before or after splitting the real-time data 1010 into separate data sub-streams, may determine a particular communication layer to send each data sub-stream across. Thus, the broadcaster 102 may send a first data sub-stream to a child network peer of a first communication layer. The child network peer of the first communication layer may send the received first data sub-stream to a subsequent network peer, and this distribution process may continue, resulting in the distribution of the first data sub-stream across the first communication layer.

As another variation, the broadcaster 102 may predefine a data sub-stream/communication layer association and send one or more distribution parameters to a network peers in peer to peer network 100, e.g., when each network peer joins the peer to peer network 100. The distribution parameters may indicate one or more communication layers associated with a particular data sub-stream.

In associating data sub-streams with communication layers, the broadcaster 102 may determine that at least one communication layer may forego association with any data sub-stream, resulting in an unassociated communication layer. In the example depicted in FIG. 10, communication layer 4 can be characterized as an unassociated communication layer because it is not associated with a particular data sub-stream. Instead, network peers in the peer to peer network 100, including the broadcaster 102, may utilize communication layer 4 to distribute any one of the data sub-streams across the peer to peer network 100.

In one embodiment, the network peer 1002 determines a selected data sub-stream to distribute across an unassociated communication layer. In this regard, network peer 1002 may determine to distribute data from sub-stream 1 1011, sub-stream 2 1012, or sub-stream 3 1013, to child network peer C₄. The network peer 1002 may, as one example, randomly select a data sub-stream for distribution across an unassociated communication layer, e.g., to child network peer C₄. The network peer 1002 may continue to distribute the randomly selected data sub-stream across an unassociated communication layer until the network peer 1002 identifies a distribution change condition, e.g., upon instruction by the broadcaster 102, receiving a request to change the selected sub-stream from the child network peer C4, receiving a user requested change through a user interface 816, or in other scenarios. Network peers in the peer to peer network may independently determine which sub-stream to send across an unassociated communication layer. For example, network peer 1002 may randomly determine to send data from stream 1 1011 across communication layer 4, e.g., to child network peer C₄. In the same unassociated communication layer, network peer P₄ may determine to send data from stream 2 1012 to network peer 1002. Similarly, the broadcaster 102 may independently determine which sub-stream data to send to its respective child network peer for unassociated communication layer 4.

The network peer 1002 may select data from a particular sub-stream to distribute across an associated communication layer in other ways as well. As one example, the network peer 1002 may randomly select a particular data sub-stream to distribute data on a per-chunk or a per-packet basis. As another example, the network peer 1002 may randomly select a particular data sub-stream to distribute data at a periodic basis, aperiodic basis, upon expiration of a distribution timer, or according to any other timing criteria.

A network peer may request a data from a particular data sub-stream be communicated across an unassociated communication layer and to the network peer. As one example, the network peer may send such a request when a parent network peer of an associated communication layer leaves the peer to peer network 100. To illustrate, network peer 1002 may receive stream 2 1012 data from network peer P₂. When network peer P₂ leaves the peer to peer network 100, network peer 1002 may temporarily cease receiving stream 2 1012 data, e.g., until network peer 1002, the broadcaster 102, and/or other network peers handle, e.g., repair, the communication interruption. In this scenario, network peer 1002 may send a stream request communication to a parent network peer of an associated communication layer. Specifically, network peer 1002 may send a stream request communication to network peer P₄ requesting that P₄ send stream 2 1012 data to network peer 1002. In one implementation, network peer 1002 may forego sending the stream request communication when identifying that network peer 1002 is already receiving data from a particular sub-stream through an unassociated communication layer. When the communication interruption in communication layer 2 is repaired, network peer 1002 may send a repair indication to network peer P₄, whereupon network peer P₄ may continue to send data from stream 2 1012 or determine a selected sub-stream to send data from.

By distributing data from a selected data sub-stream across an unassociated communication layer, network peers may collectively increase the speed at which the real-time data is distributed across the peer to peer network 100. This additional distribution of data may also increase the overall robustness of the peer to peer network 100, allowing network peers to continue to receive data from a particular sub-stream even in the event of departing network peers.

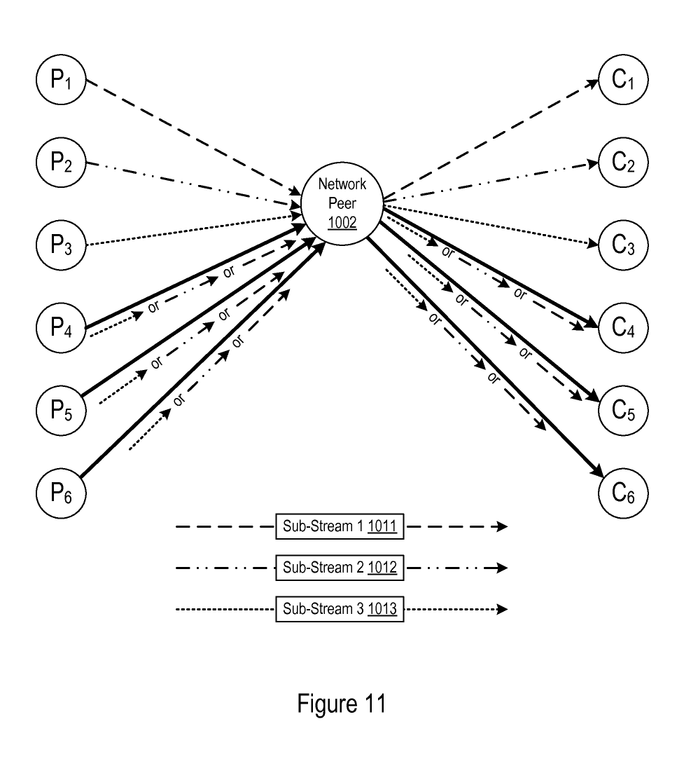

FIG. 11 shows another example of real-time data distribution 1100 in a peer to peer network 100. In the example shown in FIG. 11, the peer to peer network 100 includes six communication layers. The broadcaster 102 splits the real-time data distributed across the peer to peer network 100 into three data sub-streams. The broadcaster 102 configures the sub-stream/communication layer association by associating stream 1 1011 with communication layer 1, stream 2 1012 with communication layer 2, and stream 3 1013 with communication layer 3. Thus, in this example, the peer to peer network 100 includes three unassociated communication layers, e.g., communication layers 4, 5, and 6. Network peers in the peer to peer network 100, including the broadcaster 102, may determine a selected data sub-stream to distribute for each of the unassociated communication layers 4, 5, and 6, such as through any of the selection processes described above. In this example, the additional unassociated communication layers may enhance the robustness of the peer to peer network 100 in the event that one or more parent network peers in the associated communication layers leave the network.

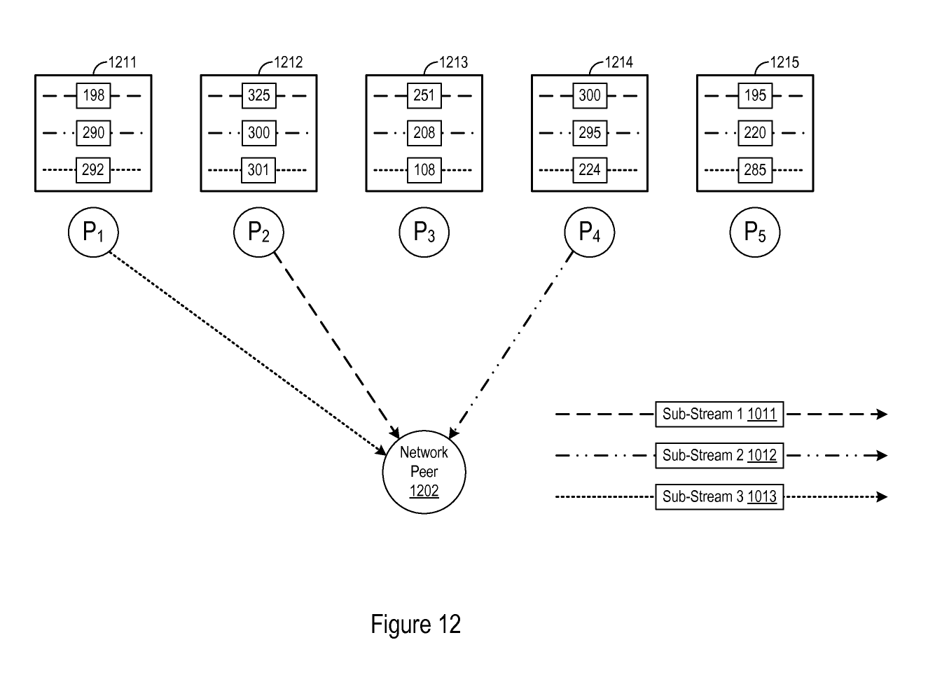

FIG. 12 shows an example of real-time data distribution 1200 in a peer to peer network 100. The example shown in FIG. 12 includes the network peer 1202, which join a peer to peer network 100 that includes five communication layers. As such, the network peer 1202 may potentially receive data from five parent network peers, labeled as P₁, P₂, P₃, P₄, and P₅. Each parent network peer of the network peer 1202 is associated with a particular communication layer 1-5. The broadcaster 102 may send any number of data streams for distribution through the peer to peer network 100. In FIG. 12, the broadcaster 102 splits real-time data into three data sub-streams—data sub-stream 1 1011, data sub-stream 2 1012, and data sub-stream 3 1013. The broadcaster 102 may additionally or alternatively send other data streams as well. The broadcaster 102 sends the sub-streams to its child network peers, for example as depicted in FIG. 11.

The network peer 1202 may receive data from less than all of its parent network peers. For instance, the network peer 1202 may receive data from a number of parent network peers equal to the number of data sub-streams distributed by the broadcaster 102. Accordingly, the network peer 1202 may receive data from three selected parent network peers, e.g., each selected parent network peer sending data from a particular sub-stream.

The network peer 1202 may selectively determine which parent network peers to receive sub-stream data from. The network peer 1202 may selectively determine a parent network peer with respect to a particular data sub-stream based on the sub-stream progression of one or more parent network peers. For example, the network peer 1202 may receive sub-stream data from the parent network peer that has received the latest chunk or packet of that particular sub-stream. Having, e.g., receiving, the latest packet or chunk in a particular data sub-stream may indicate that the selected parent network peer is closest to the broadcaster 102; that is, the selected network peer may be the least hops away from the broadcaster 102 with respect to receiving data for the specific sub-stream.

As one example shown in FIG. 12, each of the parent network peers P₁-P₅ of the network peer 1202 maintains a chunk listing, which may specify the latest chunk number of each data sub-stream that the parent network peer has received. For example, a higher chunk number may indicate that the chunk is generated later by the broadcaster 102 and represents a later, e.g., further progressed, portion of a content stream. Network peer P₁ maintains the chunk listing 1211, which indicates that network peer P₁ has received, as the latest received chunk in each sub-stream, chunk number 198 from sub-stream 1 1011, chunk number 290 from sub-stream 2 1012, and chunk number 292 from sub-stream 3 1013. Chunk listings 1212-1215 provide similar indications for network peers P₂ through P₅ respectively.

The network peer 1202 may determine a selected parent network peer for each sub-stream in any order. In FIG. 12, network peer 1202 determines a selected parent network peer to receive sub-stream data from in the following order: (1) sub-stream 1 1011; (2) sub-stream 2 1012; and (3) sub-stream 3 1013. That is, network peer 1202 selects the network peer with latest chunk number with respect to sub-stream 1 1011, which in FIG. 12 is network peer P₂. Next, network peer 1202 selects the network peer with the latest chunk number with respect to sub-stream 2 1012 from among the unselected network peers. As network peer P₂ was previously selected with respect to sub-stream 1 1011, the network peer 1012 selects remaining network peer with the latest chunk number with respect to sub-stream 2 1012, that is network peer P₄. Then, network peer 1012 determines a selected network peer with the latest chunk number with respect to stream 3 1013 from among the remaining unselected network peers, e.g., P₁, P₃, and P₅. The network peer 1012 selects peer P₁ with respect to sub-stream 3 1013. In this way, the network peer 1012 determines selected parent network peers from which the network peer 1012 receives each of the three data sub-streams.

The network peer 1202 may determine a selected parent network peer for each sub-stream in any order, in a predetermined order, or without regard to order. For example, the network peer 1202 may select a parent network peer with the latest chunk number among multiple or all of the data sub-streams. As an illustration, the network peer with the latest chunk among any data sub-stream is network peer P₂ with chunk number 325 of sub-stream 1 1011. Thus, network 1202 may determine to receive sub-stream 1 1011 data from network peer P₂. Continuing the illustration, the network peer 1202 may select a next parent network peer, from among unselected network peers, with the latest chunk number with respect to the unselected sub-streams. As network peer P₂ was previously selected for sub-stream 1 1011, the network peer 1012 selects from remaining network peers with the latest chunk number of sub-stream 2 1012 or sub-stream 3 1013. In this case, the network peer 1202 selects network peer P₄ with chunk number 295 of sub-stream 2 1012, thereby determining to receive sub-stream 2 1012 data from network peer P₄. Then, the network peer 1012 determines a selected network peer with the latest chunk number for remaining unselected sub-stream(s), which is sub-stream 3 1013, from among the remaining unselected network peers, e.g., P₁, P₃, and P₅. The network peer 1012 selects peer P₁ with chunk number 292 of sub-stream 3 1013 and determines to receive sub-stream 3 1013 data from network peer P₁. Thus, another example is presented as to how the network peer 1012 may determine selected parent network peers from which the network peer 1012 receives each of the three data sub-streams.

The network peer 1012 may send a stream request communication to each of the selected parent network peers. The stream request communication may specify the particular sub-stream data the network peer 1202 requests from a parent network peer. In FIG. 12, network peer 1202 receives sub-stream 1 1011 data from network peer P₂, sub-stream 2 1012 data from network peer P₄, and sub-stream 3 1013 data from network peer P₁. While the parent network peer determination process was described above with respect to latest chunk number, the network peer 1202 may perform the determination process according to any number of criteria, including as examples latest packet number, proximity to the broadcaster 102, latency comparisons between network peers, any other indicia of sub-stream progression, or other criteria.

The network peer 1202 may perform a parent network peer selection process at various times. For example, the network peer 1202 may periodically obtain updated stream progression data or other criteria-related data from parent network peers P₁-P₅. Concerning the example in FIG. 12, the network peer 1202 may periodically obtain updated chunk listings 1211-1215 from the network peers P₁-P₅, and subsequently determine selected parent network peers using the updated chunk listings 1211-1215. The network peer 1202 may perform the network peer selection process at other times as well, such as obtaining an unavailability indication from one or more of the parent network peers P₁-P₅, when a new network peer joins the peer to peer network 100, upon receiving a user request, when one or more network peers depart the peer to peer network 100, or at other times.

In one variation, the unselected parent network peers do not send data to the network peer 1202. In another variation, the unselected network peers randomly determine a selected data sub-stream to send to the network peer 1202, which may collectively increase the robustness of the peer to peer network 100. The exemplary distribution of real-time data 1200 shown in FIG. 12 may be implemented one or more network peers 1202 in a peer to peer network 100. In one implementation, the broadcaster 102 may distribute the real-time data according to each respective data sub-stream without regard to sub-stream progression or other criteria discussed in FIG. 12.

Network peers in the peer to peer network 100, including the children network peers of the network peer 1202, may employ the real-time data distribution process described above in FIG. 12. In that regard, the network peer 1202 may send data to one or more child network peers of the network peer 1202 when the network peer 1202 is selected by the one or more child network peer.

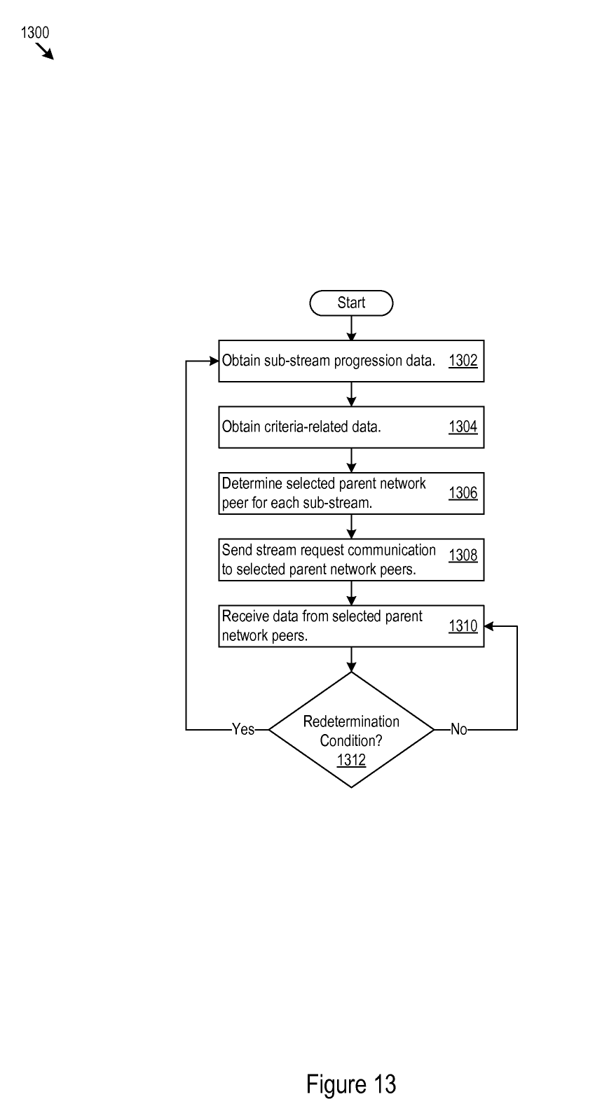

FIG. 13 shows an example of logic 1300 that a network peer may implement as hardware, software, or both. For example, the network peer 1202 may implement the logic 1300 in software as the network peer instructions 824. The network peer 1202 may obtain sub-stream progression data from one or more parent network peers of the network peer 1202 (1302). For example, the network peer 1202 may request sub-stream progression data from its parent network peers, e.g., by sending a communication to each parent network peer requesting an updated chunk listing. The network peer 1202 may additionally or alternatively obtain any other criteria-related data (1304) that the network peer 1202 may use to determine selected parent network peers from.

The network peer 1202 may determine one or more selected parent network peers to receive data from (1306). The network peer 1202 may determine a selected parent network peer based on sub-stream progression, e.g., selecting the parent network peer that has received the latest chunk, packet, segment or portion of a data sub-stream. The network peer 1202 may determine a selected parent network peer for one, some, or all of the data streams distributed by the broadcaster 102. The network peer 1202 may then coordinate with the selected parent network peer(s) to indicate which particular data sub-stream the network peer 1202 will receive from the selected parent network peer. In one implementation, the network peer 1202 sends a stream request communication to the selected parent network peers (1308), which may indicate the particular sub-stream data that the network peer 1202 requests from the parent network peer.

The network peer 1202 receives data from the selected parent network peers (1310), e.g., as determined through the parent network peer selection process. The network peer 1202 may continue to receive respective sub-stream data from the selected parent network peers until identifying a redetermination condition (1312). Redetermination indications may include when a selected parent network peer leaves the peer to peer network 100 or upon obtaining an unavailability indication with respect to a selected parent network peer. Additional examples of redetermination conditions include upon expiration of configurable timing criteria, e.g., a periodic timer, or upon identifying a particular change in the population of the peer to peer network 100, e.g., upon leaving or joining of one or more network peers. When the network peer 1202 identifies a redetermination condition, the network peer 1202 may obtain updated sub-stream progression data (1302) and/or other criteria-related data (1304) and determine one or more selected parent network peers to receive data from (1306-1310).

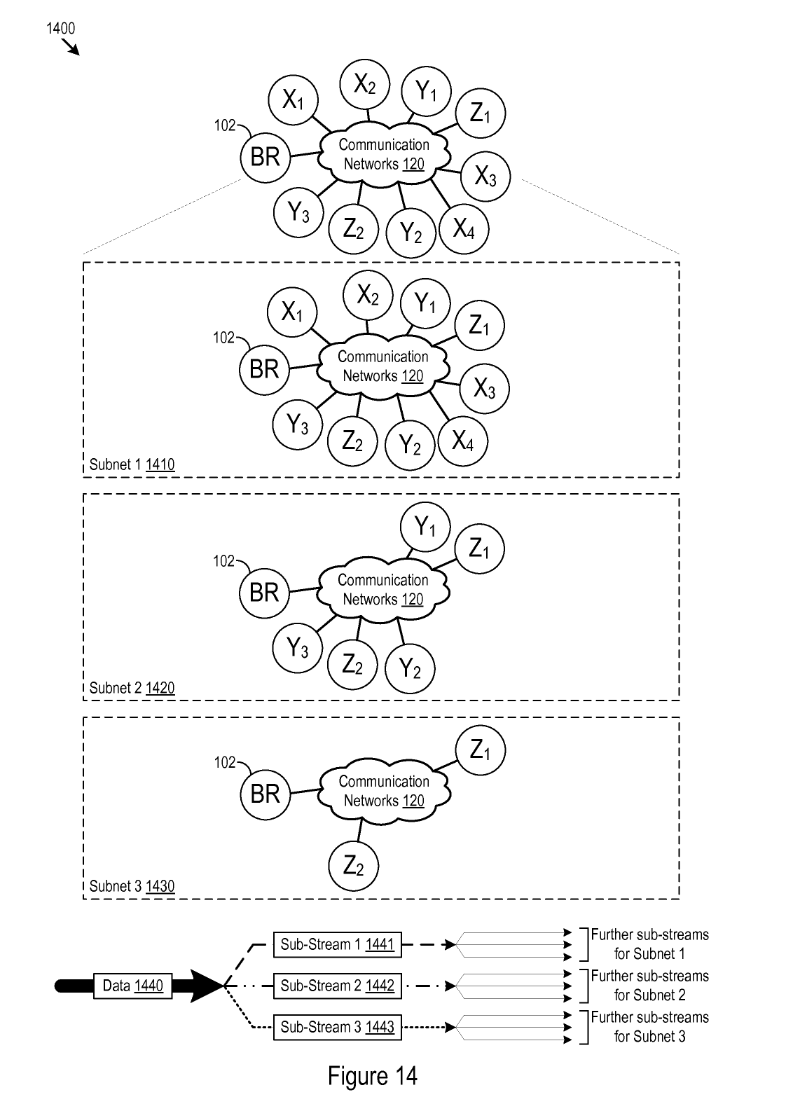

FIG. 14 shows an example of a peer to peer network 1400 that includes heterogeneous network peers. That is, the peer to peer network 1400 includes network peers that differ according to one or more communication characteristics, such as a communication capability. For example, the peer to peer network 1400 may include network peers with varying upload capabilities, e.g., upload bandwidth or capacity. To handle network peers with heterogeneous communication capabilities, a management server may implement one or more sub-networks (subnets) within the peer to peer network 1400. The discussion below refers to how management server configures and maintains subnets in the peer to peer network 1400, but any such functionality may be additionally or alternatively implemented in the broadcaster 102. In FIG. 14, the peer to peer network 1400 is divided into the three subnets labeled as subnet 1 1410, subnet 2 1420, and subnet 3 1430. Each subnet may implement a network that shares any number of common aspects with any peer to peer network discussed above, e.g., peer to peer network 100. For instance, a subnet may include multiple communication layers through which data is communicated across the subnet.

A subnet may include a particular communication or operational requirement, which may be specified as a subnet operational parameter. For example, the subnet operational parameter of a subnet may specify a particular upload bandwidth each member must contribute to communicate data across the subnet, communicate data to non-members of the subnet, or both. As one illustration, a subnet operational parameter of subnet 1 1410 may specify that members allocate 1 Mbps of their upload bandwidth, which may be further divided as specified by the subnet operational parameter. Subnets within the peer to peer network 1400 may share one or more subnet operational parameters or operate according to different operational parameters. In the example shown in FIG. 14, each of the subnets 1-3 includes a subnet operational parameter that requires a member to allocate 1 Mbps of upload capacity, which is further allocated as specified by each respective subnet operational parameter of the subnets 1-3. The management server may configure, e.g., set, the subnet operational parameters for each subnet.

The management server may classify network peers in the peer to peer network 1400 according to any number of classification criteria. Here, the broadcaster 102 classifies network peers according the maximum number of subnets a network peer can join, e.g., subnet membership capacity. Classification according to subnet membership capacity may depend on the particular subnet operational parameters set by each subnet, and accordingly reflect a network peer's communication ability with respect to the subnet operation parameters. To illustrate, and continuing the example shown in FIG. 14 where subnets 1-3 each require an allocation of 1 Mbps of upload bandwidth, network peers of class X can join, at most, one subnet. Thus, it may be understood that class X network peers, e.g., network peers X1, X₂, X₃, and X₄, have an upload bandwidth capability between 1-2 Mbps. Network peers of class Y, e.g., Y₁, Y₂, and Y₃, can join two subnets, having an upload capability between 2-3 Mbps. Along similar lines, network peers of class Z, e.g., Z₁ and Z₂, can join all three subnets and accordingly have an upload capability of 3 Mbps or more. While the exemplary classification regarding subnet membership capacity in FIG. 14 is reflective of upload capability of a network peer, the management server may specify subnet operational parameters, and consequently subnet membership criteria, in any way. Additional examples include download capability, maximum communication throughput, processing capabilities, QoS, security, signal strength, and other parameters or criteria.

The management server may classify a network peer when the network peer joins the peer to peer network 1400. In this regard, the management server may query the new network peer to determine a communication capability, e.g., upload capacity, of the new network peer. The management server may also specify which subnet(s) a network peer will join when the network peer joins the peer to peer network 1400, e.g., upon classification of the new network peer.

In one implementation, the management server specifies a predetermined subnet order in assigning which subnets a new network peer joins. In FIG. 14, the management server specifies a sequential order where network peers of class X join subnet 1 1410, network peers of class Y join subnet 1 1410 and subnet 2 1420, and network peers of class Z join subnet 1 1410, subnet 2 1420, and subnet 3 1430. A network peer may join a particular subnet in any of the ways described above, e.g., by determining an insertion position in the communication layers of a subnet similarly as described with respect to FIG. 7. The network peer may join each subnet in this way, e.g., as instructed by the management server. The broadcaster 102 may join each subnet in the peer to peer network 1400.

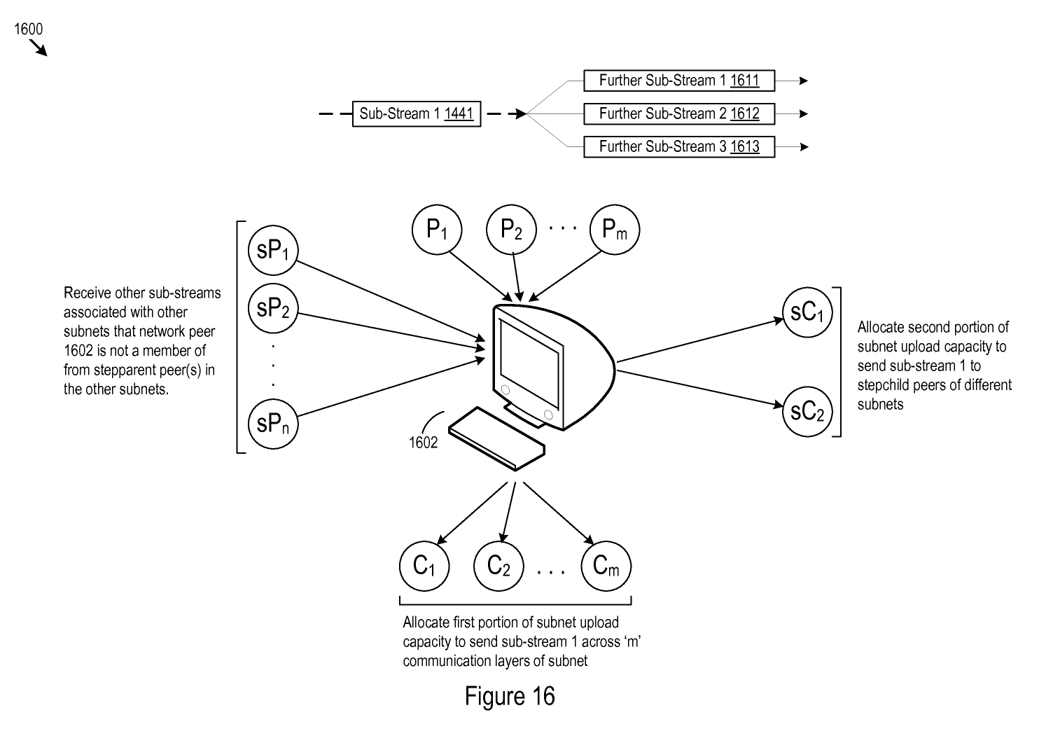

Thus, as described above, a network peer may join, e.g., become a member of, one or more subnets in the peer to peer network 1400, depending on the class of the network peer. As seen in FIG. 14, subnet 1 1410 includes network peers X₁, X₂, X₃, X₄, Y₁, Y₂, Y₃, Z₁, and Z₂ along with the broadcaster 102. Each member of subnet 1 1410 may allocate an upload bandwidth of 1 Mbps according to the subnet operational parameter of subnet 1 1410. As described in greater detail in FIG. 16, the subnet operational parameter may specify allocating a first portion of the 1 Mbps upload bandwidth to communication data across subnet 1 1410, e.g., by sending data to a child network peer for each communication layer in subnet 1 1410. The subnet operation parameter may also specify allocating a second portion of the 1 Mbps upload bandwidth to send data to one or more stepchild network peers who are not members of subnet 1 1410, if any. Subnet 2 1420 may include network peers of the peer to peer network 1400 that can join at least 2 subnets, which, in FIG. 14, includes network peers Y₁, Y₂, Y₃, Z₁, and Z₂. Members of subnet 2 1420 operate according to the subnet operation parameter of subnet 2 1420, such as allocating 1 Mbps of upload bandwidth which may be further divided as specified by the subnet operational parameters of subnet 2 1420. In a similar way, network peers Z₁ and Z₂ are members of subnet 3 1430 and operate according to the subnet operational parameters of subnet 3 1430.

Discussion now turns to how the broadcaster 102 sends real-time data, e.g., real-time data 1440, through the peer to peer network 1400 and its multiple subnets. The broadcaster 102 may determine to split the real-time data 1440 into multiple data sub-streams, for example one sub-stream for each subnet in the peer to peer network 1400. Thus, in FIG. 14, the broadcaster 102 splits the real-time data 1440 into three sub-streams labeled as sub-stream 1 1441, sub-stream 2 1442, and sub-stream 3 1443. The broadcaster 102 may also associate distribution of a sub-stream with a particular subnet, e.g., sub-stream 1 1441 will be communicated across subnet 1 1410, sub-stream 2 1442 will be communicated across subnet 2 1420, and sub-stream 3 1443 will be communicated across subnet 3 1430. The broadcaster 102 may also split each of the sub-streams into further sub-streams, depending on the number of communication layers in a particular subnet. In that regard, the broadcaster 102 splits sub-stream 1 1441 into “m” number of further sub-streams, and the broadcaster 102 may determine “m” to be less than, equal to, or more than the number of communication layers in subnet 1 1410. Broadcaster 102 respectively splits sub-stream 2 1442 and sub-stream 3 1443 into further sub-streams as well. Each sub-stream may be split different depending on, for example, the number of communication layers in each subnet.

In one implementation, the broadcaster 102 splits the real-time data 1440 into different sub-streams for distribution across the subnets in the peer to peer network 1400. That is, the broadcaster 102 splits the real-time data 1440 such that sub-stream 1 1441 (distributed across subnet 1), sub-stream 2 1442 (distributed across subnet 2), and sub-stream 3 1443 (distributed across subnet 3) are all distinct from each other. Thus, it may be understood that network peers of class X, who are members of subnet 1 but not subnet 2 and 3, may be unable to receive sub-stream 2 1442 and sub-stream 3 1443 data while communicating through subnet 1 1410. Similarly, network peers of class Y, who belong to subnets 1 and 2 but not subnet 3, may be unable to receive sub-stream 3 1443 data while communicating through subnet 1 1410 and subnet 2 1420. In this case, and as described in FIG. 16, a network peer may contact one or more peers in a subnet that the network peer is not a member of in order to receive particular sub-stream data from the subnet.

As a variation, the broadcaster 102 may generate data sub-stream such that each sub-stream includes the real-time data 1440. In this example, sub-stream 1 1441 may be the same as sub-stream 2 1442 and sub-stream 3 1443, each containing all of the real-time 1440. In this case, network peers may still contact outside network peers to receive outside sub-stream data which may increase the overall throughput of the peer to peer network 1400. It may be unnecessary for a network peer that belongs to each subnet of the peer to peer network 1400, e.g., network peers Z₁ and Z₂, to contact outside network peers because they already receive each of the data sub-streams through each of the subnets of the peer to peer network 1400.

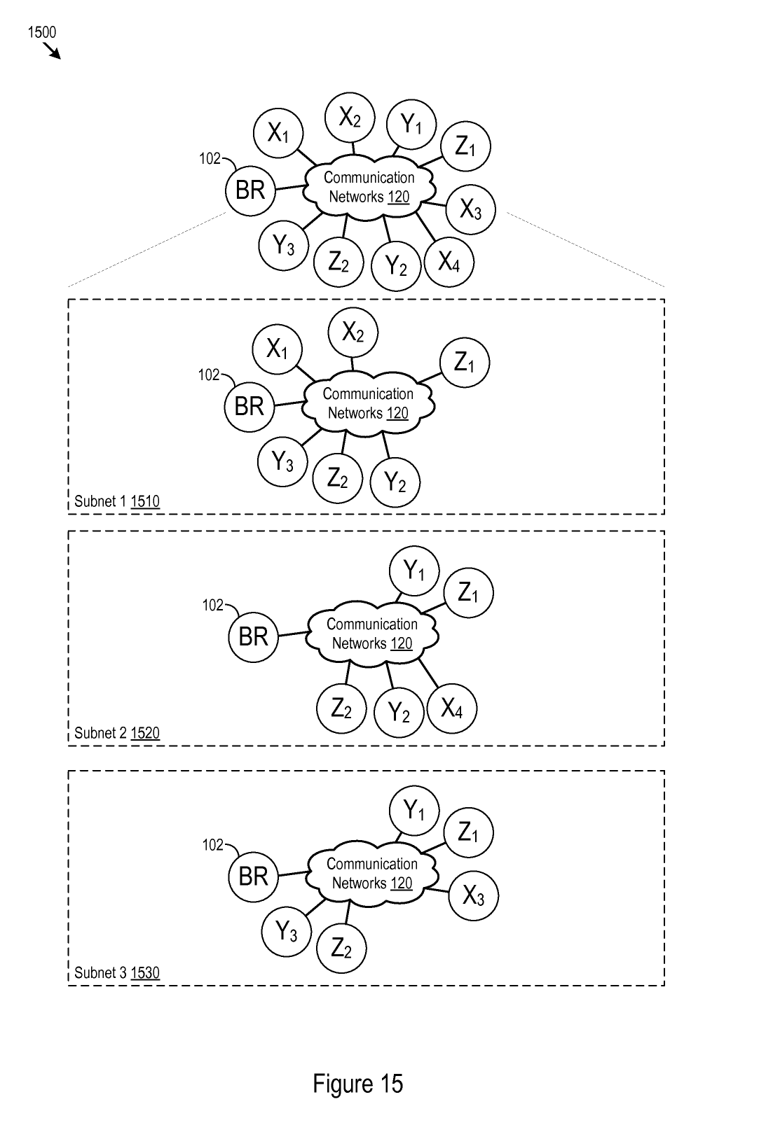

FIG. 15 shows an example of a peer to peer network 1500 that includes heterogeneous network peers. In the example shown in FIG. 15, the management server randomly assigns subnet membership to new network peers joining the peer to peer network 1500. When a new network peer joins the peer to peer network 1500, the management server may query the new network peer for a communication capability and classify the new network peer, e.g., determine the number subnets the network peer can join. Then, the management server may randomly select the particular subnets for the new network peer to join.

The random assignment of subnet membership may result in diversified subnets in the peer to peer network 1500. In FIG. 15, the peer to peer network 1500 includes three subnets labeled as subnet 1 1510, subnet 2 1520, and subnet 3 1530, which may share common subnet operational parameters as discussed with subnets 1-3 in FIG. 14. The network peers of peer to peer network 1500 may share a similar peer classification as well, including class X (one subnet membership), Y (two subnet membership), and Z (three subnet membership). When the management server identifies that a class X network peer is joining the peer to peer network 1500, the management server may randomly select one of the subnets 1-3 for the class X network peer to join. Similarly, when a class Y network peer joins the peer to peer network 1500, the management server may randomly select two of the subnets 1-3 for the class Y network peer to join. Thus, the membership of a particular subnet may include network peers of any class. As seen in FIG. 15, each of the three subnets 1-3 include class X members, class Y members, and class Z members (though class Z members, according to the classification system in FIG. 15, belong to all three subnets). Thus, the management server may randomly assign subnet membership to a new network peer, and the peer to peer network 1500 may propagate data across each of the subnets in any of the ways discussed above, e.g., in FIG. 14.

FIG. 14 describes a sequential subnet membership assignment process and FIG. 15 describes a random subnet membership assignment process. The management server may additionally or alternatively determine subnet membership in any number of ways, such as through a round-robin process, according to which subnet has the most members, least members, most members of a particular class, least members of a particular class, highest collective throughput, lowest collective throughput, or in other ways.

FIG. 16 shows an example of data flow 1600 in a heterogeneous peer to peer network, such as the peer to peer network 1400 or 1500. The exemplary data flow 1600 includes the network peer 1602. The network peer 1602 may be a member of one or more subnets in the heterogeneous peer to peer network. As an example, the network peer 1602 may be classified as a class X network peer, belonging to subnet 1 1410 of the peer to peer network 1400.

The network peer 1602 may communicate, across a particular subnet, one or more data streams or sub-streams associated with the particular subnet. In one example, as a member of subnet 1 1410, the network peer may communicate sub-stream 1 1441 data across any of “m” number of communication layers, in any of the ways discussed above, e.g., according to any of the methods discussed in FIGS. 6-8 and 10-12 above. As one example, the network peer 1602 may establish a parent-child peer relationship with “m” number of parent network peers, including the parent network peers labeled as P₁, P₂, and Pₘ. The network peer 1602 may receive sub-stream 1 1441 data from all or some of the parent network peers, depending on the data distribution technique employed by the subnet.

The broadcaster 102 may split a sub-stream associated with, e.g., distributed by, a particular subnet into any number of further sub-streams. The broadcaster 102 may split a sub-stream into a particular number of further sub-streams that is less than the number of communication layers in the subnet. Here, the broadcaster 102 may split sub-stream 1 1441 into 3 further sub-streams, which may be less than the “m” number of communication layers in subnet 1 1410. The split of sub-stream 1 1441 into 3 further sub-streams may result in further sub-stream 1 1611, further sub-stream 2 1612, and further sub-stream 3 1613. The network peer 1602 may receive data from further sub-stream 1 1611, further sub-stream 2 1612, or further sub-stream 3 1613 through one or more selected parent network peers and communication paths, e.g., as described in FIG. 10, 11, or 12. As another variation, the broadcaster 102 may split a sub-stream, e.g., sub-stream 1 1441, into “m” number of sub-streams to distribute across the “m” number of communication layers in subnet 1 1410 as well. In yet another variation, the broadcaster 102 may not split the sub-stream 1 1441 into any further sub-streams, and distribute sub-stream 1-1441 through one, some, or all of the communication layers of subnet 1 1410.

A network peer may belong to no subnet, one subnet, or multiple subnets. A network peer's subnet membership may determine the sub-stream data the network peer receives from parent network peers of each subnet the network peer belongs to. Continuing the example where the network peer 1602 where network peer belongs to a single subnet, e.g., subnet 1 1410, the network peer may receive sub-stream 1 1441 data from its parent network peers P₁-Pₘ, but may not receive data of other sub-streams, e.g., sub-stream 2 1442 or sub-stream 3 1443, from its parent network peers.

The network peer 1602 may contact outside network peers belonging to a subnet that the network peer does not belong to. In that regard, the network peer 1602 may determine one or more outside network peers to receive other sub-stream data that the network peer 1602 does not receive through the subnets that the network peer 1602 does belong to. These one or more outside network peers from whom the network peer 1602 receives other sub-stream data may be referred to as stepparents of network peer 1602. In FIG. 16, the network peer 1602 receives other sub-stream data from multiple stepparent network peers, including those labeled as sP₁, sP₂, and sPₙ.

To continue an example described above, the network peer 1602 may be a member of subnet 1 1410, but not a member of subnet 2 1420 and subnet 3 1430. The network peer 1620 may contact a member of subnet 2 1420, who may provide a stepparent availability indication to the network peer 1602. The stepparent availability indication may indicate any network peer in subnet 2 1420 that can act as a stepparent to network peer 1602 and provide network peer 1602 with sub-stream 2 1442 data. Network peers in a particular subnet may monitor and maintain stepparent availability for the network peers in the particular subnet. For example, network peers may regularly, periodically, or aperiodically broadcast their availability to serve as a stepparent and distribute other sub-stream data to other network peers in a subnet. As another variation, the network peer 1602 may contact the management server and receive a stepparent availability indication maintained by the management server. In this way, the network peer 1602 may identify one or more network peers in subnet 2 1402 available to send sub-stream 2 1442 data to the network peer 1602. The network peer 1602 may send a non-member sub-stream data request to the identified network peers available to act as a stepparent network peer and receive the other sub-stream data, e.g., sub-stream 2 1442 data, from the stepparent network peers, e.g., sP1, sP2, and sPn. The network peer 1602 may repeat a similar process for each subnet that the network peer 1602 does not belong to, thus allowing the network peer 1602 to receive data from each subnet in a heterogeneous peer to peer network, such as 1400. The network peer 1602 may establish multiple stepparent connections in order to meet a streaming bandwidth requirement or threshold, e.g., receive other sub-stream data at a particular rate such as 2 Mbps. As another example, the network peer 1602 may establish a number of stepparent connections with respect to a particular subnet to receive the other sub-stream data at a rate equal to or greater than the communication rate in which the other sub-stream data is communicated by network peer members in the particular subnet.

The network peer 1602 may also act as a stepparent to other network peers outside of a subnet that the network peer 1602 is a member of. For example, the network peer 1602 may receive a non-member sub-stream data request from a network peer that does not belong to a subnet that the network peer 1602 belongs to. As one illustration, network peer 1602 may belong to subnet 1 1510, as described in FIG. 15. Accordingly, the network peer 1602 may receive sub-stream data associated with subnet 1 1510 from one or more parent network peers in subnet 1 1510. The network peer 1602 may receive a non-member sub-stream data request from a requesting network peer belonging only to subnet 3 1530 that only receives sub-stream data associated with subnet 3 1530. The network peer 1602 may send sub-stream data associated with sub-net 1 1510 to the requesting network peer, thus serving as a stepparent to the requesting network peer. In this way, the network peer 1602 may form one or more stepparent-stepchild peer relationships, and distribute sub-stream data associated with a subnet that the network peer is a member of to its stepchild network peers, such as sC₁ and sC₂.

The stepparent availability of a network peer (e.g., whether the network peer can send sub-stream data associated with a subnet the network peer belongs to a network peer outside the subnet) may be configured according to a subnet operational parameter. For example, the subnet operational parameter may specify a maximum number of stepchild network peer that the network peer 1602 can send sub-stream data to. In FIG. 16, the subnet operational parameter may specify that the network peer 1602 can send sub-stream data to a maximum of two stepchild network peers, thus controlling the stepparent availability of the network peer 1602.

The subnet operational parameter may specify allocation of one or more communication capabilities of a network peer in a subnet. For instance, in FIG. 16, the subnet operational parameter specifies that network peer 1602 allocate a first portion of subnet upload capacity, e.g., a first portion of an overall 1 Mbps subnet allocation requirement, for sending sub-stream data across the communication layers in the subnet. The subnet operational parameter also specifies that the network peer 1602 allocate a second portion of the subnet upload capacity for sending the subnet's sub-stream data to one or more stepchild network peers, e.g., sC₁ and sC₂.

The subnet features described above may allow a heterogeneous peer to peer network to more effectively, efficiently, and robustly distribute real-time data. That is, network peers with additional or greater communication capabilities may share their resources across multiple subnets, thereby increasing the overall throughput of the peer to peer network. As one illustration, a peer to peer network may achieve a greater overall data streaming rate than supported by some members of the peer to peer network. In one example in conjunction with FIG. 14, the overall streaming rate supported by the peer to peer network 1400 may be greater than the maximum streaming rate, e.g., upload capacity, of class X network peers in the peer to peer network 1400.

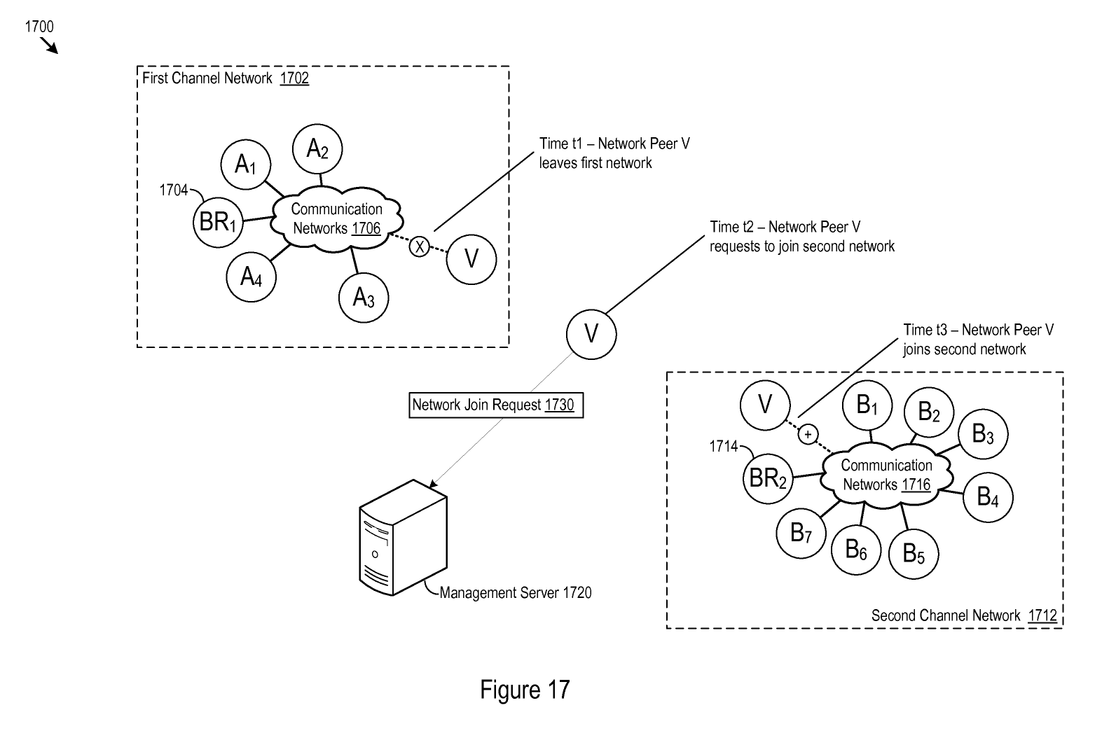

FIG. 17 shows a timing example 1700 of multi-channel peer to peer streaming. The timing example 1700 includes a first channel network 1702 that distributes an A/V program associated with a first content channel. The first channel network 1702 includes a first broadcaster 1704 and multiple network peers labeled as A₁, A₂, A₃, and A₄ that are interconnected through the communication networks 1706. The timing example 1700 also includes a second channel network 1712 that distributes an A/V program associated with a second content channel. The second channel network 1712 includes a second broadcaster 1704 and multiple network peers labeled as B₁, B₂, B₃, B₄, B₅, B₆, and B₇, which are interconnected through the communication networks 1716.

The first broadcaster 1704 and the second broadcaster 1714 may differ according to the content each broadcaster distributes. As seen in FIG. 17, the first broadcaster 1704 and second broadcaster 1714 may distribute their respective channel content across different communication networks and/or to different network peers. The first broadcaster 1704 and second broadcaster 1714 may be operated by the same or different commercial entities and may be implemented through the same or different physical devices, e.g., content and distribution servers. As another example, the first broadcaster 1704, second broadcaster 1714, or both may be non-commercial electronic devices that distribute content as well, e.g., a personal laptop or desktop computer of a user. The first broadcaster 1704 and the second broadcaster 1714, and their respective peer to peer networks, may be managed by a management server 1720.

The management server 1720, as also seen in FIG. 17, may implement any of the peer to peer network management capabilities described above, and may manage any number of peer to peer networks such as the first channel network 1702 and the second channel network 1712. In that regard, the management server 1720 may maintain a network peer list 140, communication path listings 142, a broadcasting layer parameter 143, and/or other management or configuration data for managed peer to peer networks, e.g., with respect to both the first channel network 1702 and the second channel network 1702. The first channel network 1702 and the second channel network 1712 may share any number of common aspects with any of the peer to peer networks described above.

Prior to time t1, network peer V is part of the first channel network 1702. In that regard, network peer V may receive real-time data of the first channel, e.g., as sub-streams communicated across multiple layers of the first channel network 1702. At a time t1, the network peer V leaves the first channel network, e.g., when network peer V receives a channel change request from a user from the first channel to the second channel. Network peers in the first channel network 1702 may resolve the communication interruption caused when network peer V leaves, as discussed above, for example, in FIG. 4 and FIG. 5.

At time t2, network peer V may contact the management server by sending a network join request 1730. The network join request 1730 may specify a particular network that network peer V requests to join or particular content network peer V requests to receive. The management server 1720 may respond by sending one or more selected parent network peers that network peer V may contact in order to join the second channel network 1712, e.g., insertion points in communication paths of the communication layers in the second channel network 1712. As one example, the management server 1720 may provide a listing of IP addresses which identify the parent network peer(s) whose outgoing communication link network peer V should break in. At time t3, network peer V joins the second channel network 1712, for example as described in FIG. 3 and FIG. 6, and may then receive content, e.g., real-time data, of the second channel. Thus, multi-channel peer to peer streaming may be supported by the broadcaster 102 and/or management server 1720 by treating a channel change as a departing peer in a first network distributing first channel data and a new peer joining a second network distributing second channel data. In this way, an efficient, elegant implementation of multi-channel peer to peer streaming is provided with minimal overhead.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability described above may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the systems and methods have been described, it will be apparent to those of ordinary skill in the art that many more embodiments and implementations are possible within the scope of the systems and methods. Accordingly, the systems and methods are not to be restricted except in light of the attached claims and their equivalents.

What is claimed is:

1. A method comprising:
in a network device comprising a processor, memory, and communication interface, the network device communicating through a peer to peer network:
receiving data from a parent network peer;
sending data to a child network peer;
identifying, via the processor, a communication interruption caused by the child network peer and a subsequent downstream network peer leaving the peer to peer network;
resolving, via the processor, the communication interruption by:
identifying a new child network peer; and
sending data to the new child network peer.

2. The method of claim 1, comprising:
concurrently receiving first data from a first parent network peer associated with a first communication layer and second data from a second parent network peer associated with a second communication layer;
sending the first data to a first child network peer associated with the first communication layer; and
sending the second data to a second child network peer associated with the second communication layer.

3. The method of claim 1, where identifying the new child network peer comprises accessing a descendant list, the descendant list identifying the child network peer, a grandchild network peer, and a great grandchild network peer of the network device.

4. The method of claim 3, comprising identifying the great grandchild network peer as the new child network peer.

5. The method of claim 3, further comprising:
updating the descendant list after resolving the communication interruption.

6. The method of claim 1, further comprising:
identifying a communication interruption caused by the parent network peer and a preceding upstream network peer leaving the peer to peer network;
resolving the communication interruption by:
identifying a new parent network peer; and
receiving data from the new parent network peer.

7. The method of claim 1, comprising:
determining that the communication interruption affects multiple communication layers that the network device communications across; and where resolving the communication interruption comprises:
identifying a new child network peer for each of the affected multiple communication layers.

8. A system comprising:
a communication interface; and
peer logic in communication with the communication interface, the peer logic operable to:
receive data from a parent network peer in a peer to peer network through the communication interface;
send data to a child network peer in the peer to peer network through the communication interface;
identify a communication interruption caused by the child network peer and a subsequent downstream network peer leaving the peer to peer network;
resolve the communication interruption by:
identifying a new child network peer; and
sending data to the new child network peer through the communication interface.

9. The system of claim 8, where the peer logic is operable to:
concurrently receive first data from a first parent network peer associated with a first communication layer of the peer to peer network and second data from a second parent network peer associated with a second communication layer of the peer to peer network;
send the first data to a first child network peer associated with the first communication layer through the communication interface; and
send the second data to a second child network peer associated with the second communication layer through the communication interface.

10. The system of claim 8, where the peer logic is operable to identify the new child network peer by accessing a descendant list, the descendant list identifying the child network peer, a grandchild network peer, and a great grandchild network peer.

11. The system of claim 10, where the peer logic is operable to identify the great grandchild network peer as the new child network peer.

12. The system of claim 10, where the peer logic is further operable to update the descendant list after resolving the communication interruption

13. The system of claim 8, where the peer logic is further operable to:
identify a communication interruption caused by the parent network peer and a preceding upstream network peer leaving the peer to peer network;
resolve the communication interruption by:
identifying a new parent network peer; and
receiving data from the new parent network peer through the communication interface.

14. The system of claim 8, where the peer logic is further operable to:
determine the communication interruption affects multiple communication layers that the network device communications across; and
where the peer logic is operable to resolve the communication interruption by:
identifying a new child network peer for each of the affected multiple communication layers.

15. A non-transitory computer readable medium comprising:
processor executable instructions stored on the non-transitory computer readable medium, the processor executable instructions when executed by a processor, cause the processor to:
receive data from a parent network peer in a peer to peer network;
send data to a child network peer in the peer to peer network;
identify a communication interruption caused by the child network peer and a subsequent downstream network peer leaving the peer to peer network;
resolve the communication interruption by:
identifying a new child network peer; and
sending data to the new child network peer through the communication interface.

16. The non-transitory computer readable medium of claim 15, where the processor executable instructions cause the processor to:
concurrently receive first data from a first parent network peer associated with a first communication layer of the peer to peer network and second data from a second parent network peer associated with a second communication layer of the peer to peer network;
send the first data to a first child network peer associated with the first communication layer; and
send the second data to a second child network peer associated with the second communication layer.

17. The non-transitory computer readable medium of claim 15, where the processor executable instructions cause the processor to:
identify the new child network peer by accessing a descendant list, the descendant list identifying the child network peer, a grandchild network peer, and a great grandchild network peer.

18. The non-transitory computer readable medium of claim 17, where the processor executable instructions further cause the processor to:
identify the great grandchild network peer as the new child network peer.

19. The non-transitory computer readable medium of claim 17, where the processor executable instructions further cause the processor to update the descendant list after resolving the communication interruption.

20. The non-transitory computer readable medium of claim 17, where the processor executable instructions further cause the processor to:
determine that the communication interruption affects multiple communication layers that the network device communications across; and where resolving the communication interruption comprises:
identify a new child network peer for each of the affected multiple communication layers.

21. A device comprising:
a communication interface; and
peer logic in communication with the communication interface, the peer logic operable to:
join a peer to peer network that includes three or more communication layers through which a data stream comprising a first data sub-stream and a second data sub-stream is communicate;
receive, through the communication interface, the first data sub-stream from a first parent network peer in the peer to peer network;
receive, through the communication interface, the second data sub-stream from a second parent network peer in the peer to peer network;
receive, through the communication interface, data from a third parent network peer in the peer to peer network, where the data comprises the first data sub-stream, the second data sub-stream, or both.

22. The device of claim 21, where the peer logic is further operable to:
send, through the communication interface, the first data sub-stream to a first child network peer in the peer to peer network;
send, through the communication interface, the second data sub-stream to a second child network peer in the peer to peer network;
determine a selected data stream from among the first and second data sub-streams; and
send, through the communication interface, the selected data sub-stream to a third child network peer in the peer to peer network.

23. The device of claim 21, where the first, second, and third parent network peers are each associated with different communication layer in the peer to peer network.

24. The device of claim 21, where the first and second data sub-streams form an audio/video stream.
